(19) United States
(12) Patent Application Publication
(10) Pub. No.: US 2026/0197040 A1
(43) Pub. Date: Jul. 9, 2026

(54) FREQUENCY COMPENSATION FOR COMMUNICATING OVER WIRED INFRASTRUCTURE USING RADIO ACCESS TECHNOLOGY

(71) Applicant: QUALCOMM Incorporated, San Diego, CA (US)

(72) Inventors: Carl HARDIN, Encinitas, CA (US); Rahul MALIK, San Diego, CA (US); Omar MEHANNA, San Diego, CA (US); Ravinder KUMAR, San Diego, CA (US)

(21) Appl. No.: 19/442,685

(22) Filed: Jan. 7, 2026

Related U.S. Application Data
(60) Provisional application No. 63/743,210, filed on Jan. 8, 2025.

(51) Int. Cl. H04B 7/0413; H04B 7/12

(52) U.S. Cl. CPC H04B 7/0413; H04B 7/12

(57) ABSTRACT

Various aspects generally relate to communication. In some aspects, a receiver may receive, from a transmitter over a wired infrastructure, a frequency division multiplexed (FDM) signal. The receiver may map the FDM signal to a spatial division multiplexed (SDM) signal including multiple spatial layers, wherein the SDM signal mapped to the FDM signal compensates for a frequency error between the transmitter and the receiver. The receiver may provide the SDM signal to a multiple-input multiple-output (MIMO) transceiver. Numerous other aspects are described.

### CROSS-REFERENCE TO RELATED APPLICATION

This patent application claims priority to U.S. Provisional Patent Application No. 63/743,210, filed on Jan. 8, 2025, entitled “FREQUENCY COMPENSATION FOR COMMUNICATING OVER WIRED INFRASTRUCTURE USING RADIO ACCESS TECHNOLOGY,” and assigned to the assignee hereof. The disclosure of the prior Application is considered part of and is incorporated by reference into this patent Application.

### FIELD OF THE DISCLOSURE

Aspects of the present disclosure generally relate to communication and specifically relate to techniques, apparatuses, and methods associated with frequency compensation for communicating over a wired infrastructure using a radio access technology.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

For example, one potential use case for a multiple-access RAT, such as 5G NR, is to support communication using the RAT over cable to provide internet service or other communication services over a deployed cable infrastructure (e.g., as an alternative to or an improvement upon the Data Over Cable Service Interface Specification (DOCSIS) standard that permits adding high-bandwidth data transfer to an existing cable television system). However, one challenge that arises when using a RAT to communicate over a cable infrastructure is that a RAT is generally designed for wireless channels and employs MIMO to exploit spatial diversity in the wireless channels. For example, in MIMO communication, multiple signals (e.g., multiple layers or multiple data streams) are simultaneously transmitted and/or received over the same time and frequency resources to exploit multipath propagation using various spatial processing or spatial multiplexing operations. However, cable channels are single-input single-output (SISO) in nature. Accordingly, in a system that supports communication using a RAT over a cable infrastructure (which may be referred to herein as a RoC system, or an NR over cable (NRoC) system where NR is the RAT used to communicate over the cable infrastructure), techniques are needed to leverage the capabilities and envelope of wireless radios that are designed for wireless applications. Furthermore, similar challenges may arise when developing systems to use a RAT to communicate over other wired infrastructure, such as power-line communication (PLC) that carries data on a wiring infrastructure used for electric power transmission or electric power distribution.

### SUMMARY

Some aspects described herein relate to a method of communication performed by a receiver. The method may include receiving, from a transmitter over a wired infrastructure, a frequency division multiplexed (FDM) signal. The method may include mapping, by a frequency translation component, the FDM signal to a spatial division multiplexed (SDM) signal that includes multiple spatial layers, wherein the SDM signal mapped to the FDM signal compensates for a frequency error between the transmitter and the receiver. The method may include providing the SDM signal to a multiple-input multiple-output (MIMO) transceiver.

Some aspects described herein relate to a method of communication performed by a transmitter. The method may include providing, by a MIMO transceiver, an SDM signal that includes multiple spatial layers to a frequency translation component. The method may include mapping, by the frequency translation component, the SDM signal to an FDM signal. The method may include transmitting, to a receiver over a wired infrastructure, the FDM signal, wherein the FDM signal transmitted over the wired infrastructure compensates for a frequency error between the transmitter and the receiver.

Some aspects described herein relate to an apparatus for wireless communication at a receiver. The apparatus may include one or more memories and one or more processors coupled to the one or more memories. The one or more processors may be configured to cause the receiver to receive, from a transmitter over a wired infrastructure, an FDM signal. The one or more processors may be configured to cause the receiver to map the FDM signal to an SDM signal that includes multiple spatial layers, wherein the SDM signal mapped to the FDM signal compensates for a frequency error between the transmitter and the receiver. The one or more processors may be configured to cause the receiver to provide the SDM signal to a MIMO transceiver.

Some aspects described herein relate to an apparatus for wireless communication at a transmitter. The apparatus may include one or more memories and one or more processors coupled to the one or more memories. The one or more processors may be configured to cause the transmitter to provide an SDM signal that includes multiple spatial layers to a frequency translation component. The one or more processors may be configured to cause the transmitter to map the SDM signal to an FDM signal. The one or more processors may be configured to cause the transmitter to transmit, to a receiver over a wired infrastructure, the FDM signal, wherein the FDM signal transmitted over the wired infrastructure compensates for a frequency error between the transmitter and the receiver.

Some aspects described herein relate to a non-transitory computer-readable medium that stores a set of instructions for wireless communication by a receiver. The set of instructions, when executed by one or more processors of the receiver, may cause the receiver to receive, from a transmitter over a wired infrastructure, an FDM signal. The set of instructions, when executed by one or more processors of the receiver, may cause the receiver to map the FDM signal to an SDM signal that includes multiple spatial layers, wherein the SDM signal mapped to the FDM signal compensates for a frequency error between the transmitter and the receiver. The set of instructions, when executed by one or more processors of the receiver, may cause the receiver to provide the SDM signal to a MIMO transceiver.

Some aspects described herein relate to a non-transitory computer-readable medium that stores a set of instructions for wireless communication by a transmitter. The set of instructions, when executed by one or more processors of the transmitter, may cause the transmitter to provide an SDM signal that includes multiple spatial layers to a frequency translation component. The set of instructions, when executed by one or more processors of the transmitter, may cause the transmitter to map the SDM signal to an FDM signal. The set of instructions, when executed by one or more processors of the transmitter, may cause the transmitter to transmit, to a receiver over a wired infrastructure, the FDM signal, wherein the FDM signal transmitted over the wired infrastructure compensates for a frequency error between the transmitter and the receiver.

Some aspects described herein relate to an apparatus for wireless communication. The apparatus may include means for receiving, from a transmitter over a wired infrastructure, an FDM signal. The apparatus may include means for mapping the FDM signal to an SDM signal that includes multiple spatial layers, wherein the SDM signal mapped to the FDM signal compensates for a frequency error between the transmitter and the apparatus. The apparatus may include means for providing the SDM signal to a MIMO transceiver.

Some aspects described herein relate to an apparatus for wireless communication. The apparatus may include means for providing an SDM that includes multiple spatial layers to a frequency translation component. The apparatus may include means for mapping the SDM signal to an FDM signal. The apparatus may include means for transmitting, to a receiver over a wired infrastructure, the FDM signal, wherein the FDM signal transmitted over the wired infrastructure compensates for a frequency error between the apparatus and the receiver.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network.

FIG. 2 is a diagram illustrating an example disaggregated base station architecture.

FIG. 3 is a diagram illustrating an example wireless transceiver architecture.

FIGS. 4A-4F are diagrams illustrating examples associated with frequency division multiplexing (FDM) multiple-input multiple-output (MIMO) configurations to communicate over a cable infrastructure using a radio access technology (RAT).

FIG. 5 is a diagram illustrating an example associated with a frequency division duplexing (FDD) configuration to communicate over a cable infrastructure using a RAT.

FIGS. 6A-6C are diagrams illustrating examples associated with time division duplexing (TDD) configurations to communicate over a cable infrastructure using a RAT.

FIGS. 7A-7B are diagrams illustrating examples associated with multi-system operations to communicate over a cable infrastructure using a RAT.

FIGS. 8A-8E are diagrams illustrating examples associated with frequency translation errors that may occur when translating a signal between a frequency division multiplexed (FDM) and a spatial division multiplexed (SDM) configuration.

FIG. 9 is a diagram illustrating one or more examples associated with frequency compensation for communicating over a wired infrastructure using a RAT.

FIG. 10 is a flowchart illustrating an example process performed, for example, by a receiver.

FIG. 11 is a flowchart illustrating an example process performed, for example, by a transmitter.

FIGS. 12-13 are diagrams of example apparatuses for performing frequency compensation to communicate over a wired infrastructure using a RAT.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

As described herein, a communication system may support using a radio access technology (RAT) to communicate over a cable or wired infrastructure (which may be referred to herein as a RoC system, or a New Radio (NR) over cable (NRoC) system in cases where NR is the RAT used to communicate over the wired infrastructure). For example, NRoC may leverage NR waveforms and wireless communication techniques to enable broadband communication over coaxial cable networks or other wired infrastructure. NR and other wireless waveforms are generally designed for wireless channels and to exploit spatial diversity of wireless channels to boost throughput. For example, techniques such as multiple-input multiple-output (MIMO) may be used, where multiple spatial signals (e.g., multiple layers or multiple data streams) are simultaneously transmitted and/or received over multiple antennas using the same time and frequency resources to exploit multipath propagation using various spatial processing or spatial multiplexing operations, while the receiver employs advanced processing techniques to recover the data stream. However, cable channels are single-input single-output (SISO) in nature, and typically have only a single spatial path between a transmitter and a receiver (e.g., the coaxial cable or wire).

Accordingly, to utilize the maximum envelope associated with a chipset designed to support NR or another RAT, techniques such as frequency division multiplexing (FDM) may be applied to enable communication over a wired infrastructure. For example, MIMO layers and/or component carriers associated with a transmission may be mixed to different coaxial frequencies or other frequency spectrum associated with the wired infrastructure prior to transmission over the wired infrastructure. Furthermore, FDM configurations may be similarly applied at a receiver, where a signal received over the cable infrastructure may be mixed back to the same frequency (e.g., a radio frequency (RF)) prior to reception at a wireless receiver. For example, in some cases, an external frequency translator that includes one or more mixers and filters may be used to translate an NR (or other wireless) MIMO waveform to an FDM MIMO waveform at a transmitter and/or to translate an FDM MIMO waveform to an NR (or other wireless) MIMO waveform at a receiver. The external frequency translator may be coupled to a front-end of a wireless transceiver. The external frequency translator may be built around an existing wireless transceiver, and may generally favor a layer-first mapping. However, an external frequency translator introduces additional components that may add to device cost. Alternatively, the frequency translation function may be performed by a transceiver integrated circuit coupled to a wireless modem, which may be suitable for different component carrier and/or layer mappings that may be useful for network planning. However, wireless transceivers may not universally support the ROC translation functionality.

As described herein, crystal oscillators (XOs) are often used as reference clock sources in modern digital communications equipment due to XOs having a relatively low cost. However, XOs are subject to a higher frequency error and temperature variance compared to more expensive (and more precise) clock sources, such as an oven-controlled crystal oscillator (OCXO) or a voltage-controlled temperature-compensated crystal oscillator (VCTCXO). In cases where an XO is used as a reference clock source, the frequency error between the transmitter and the receiver is typically measured and compensated for using digital signal processing techniques in the wireless modem and transceiver integrated circuits. However, when an (external) frequency translator is used to enable translation between an FDM MIMO waveform suitable for transmission over a wired infrastructure and a MIMO waveform that can be received or transmitted by a wireless transceiver, the frequency translator poses frequency compensation challenges that are not addressed by typical RAT processing flows.

Various aspects described herein relate to techniques associated with frequency compensation for communicating over a wired infrastructure using a RAT, such as NR. For example, in a device that uses a wireless transceiver and a frequency translator to translate between FDM MIMO waveforms suitable for transmission over a wired infrastructure and MIMO waveforms that can be received or transmitted by the wireless transceiver, automatic frequency control (AFC) may be applied to correct a frequency error on a phase locked loop (PLL) of the external mixer. In this way, an error term associated with the transmitted or received signal may be reduced by correcting for an error associated with an external mixer XO, enabling coherent combining for multiple spatial signals across multiple reception layers. Additionally, or alternatively, a residual frequency error and fast-fluctuation associated with a signal communicated over a wired infrastructure may be eliminated or reduced by using a common reference clock between the transmitter and the receiver. For example, a clock reference may be broadcast by a network node over the wired infrastructure to all UEs or customer premise equipments (CPEs) served by the network node using in-band or out-of-band signaling. Additionally, or alternatively, rather than using relatively low-precision XOs with errors that are often measured in parts-per-million (ppm), the frequency translator may use high-precision calibrated parts as a local clock source, such as an OCXO, VCTCXO, or other clock source that can provide a precise reference frequency that may be measured in parts-per-billion (ppb).

As described above, wireless communication systems may be deployed to provide various services, which may involve carrying or supporting voice, text, other messaging, video, data, and/or other traffic. Some wireless communications systems may employ multiple-access RATs. The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G NR is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

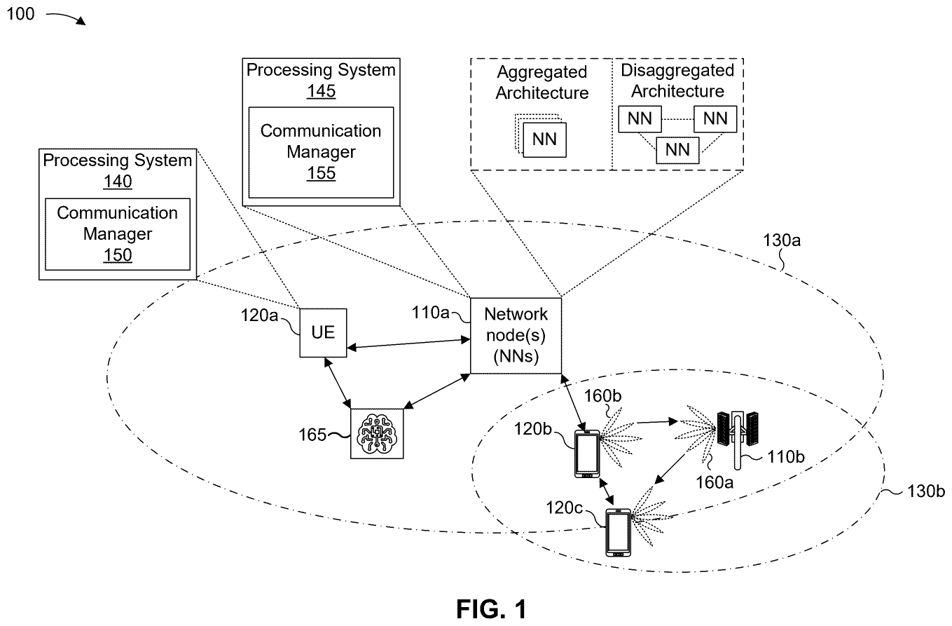

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FRI is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FRI characteristics or FR2 characteristics, and thus may effectively extend features of FRI or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

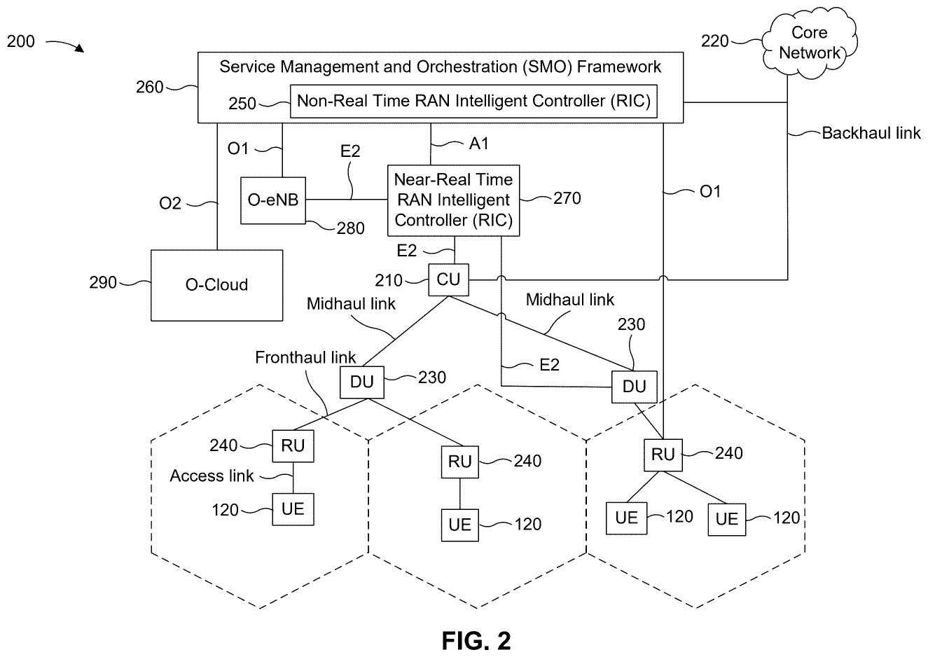

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUS). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (SS) (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples.

In some aspects, the UE 120 may include a communication manager 150. As described in more detail elsewhere herein, the communication manager 150 may receive, from a transmitter over a wired infrastructure, an FDM signal; map, by a frequency translation component, the FDM signal to a spatial division multiplexed (SDM) signal that includes multiple spatial layers, wherein the SDM signal mapped to the FDM signal compensates for a frequency error between the transmitter and the receiver; and provide the SDM signal to a MIMO transceiver. Additionally, or alternatively, the communication manager 150 may provide, by a MIMO transceiver, an SDM signal that includes multiple spatial layers to a frequency translation component; map, by the frequency translation component, the SDM signal to an FDM signal; and transmit, to a receiver over a wired infrastructure, the FDM signal, wherein the FDM signal transmitted over the wired infrastructure compensates for a frequency error between the transmitter and the receiver. Additionally, or alternatively, the communication manager 150 may perform one or more other operations described herein.

In some aspects, the network node 110 may include a communication manager 155. As described in more detail elsewhere herein, the communication manager 155 may receive, from a transmitter over a wired infrastructure, an FDM signal; map, by a frequency translation component, the FDM signal to an SDM signal that includes multiple spatial layers, wherein the SDM signal mapped to the FDM signal compensates for a frequency error between the transmitter and the receiver; and provide the SDM signal to a MIMO transceiver. Additionally, or alternatively, the communication manager 155 may provide, by a MIMO transceiver, an SDM signal that includes multiple spatial layers to a frequency translation component; map, by the frequency translation component, the SDM signal to an FDM signal; and transmit, to a receiver over a wired infrastructure, the FDM signal, wherein the FDM signal transmitted over the wired infrastructure compensates for a frequency error between the transmitter and the receiver. Additionally, or alternatively, the communication manager 155 may perform one or more other operations described herein.

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

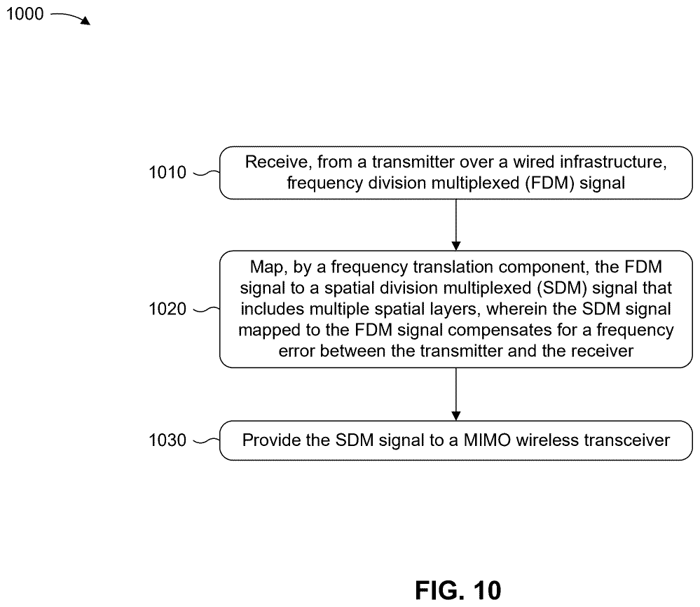

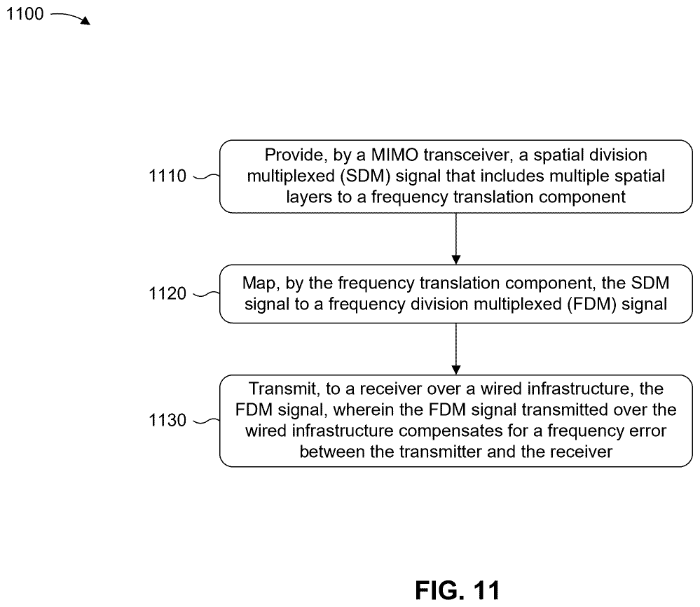

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with frequency compensation for communicating over a wired infrastructure using a RAT, as described in more detail elsewhere herein. For example, the processing system 145 of the network node 110, the processing system 140 of the UE 120, the CU 210, the DU 230, or the RU 240 may perform or direct operations of, for example, process 1000 of FIG. 10, process 1100 of FIG. 11, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

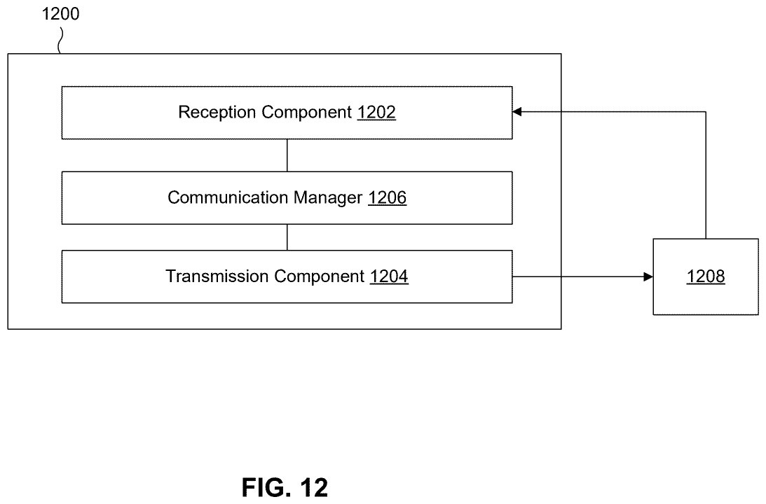

In some aspects, a receiver (e.g., the UE 120 or the network node 110) includes means for receiving, from a transmitter over a wired infrastructure, an FDM signal; means for mapping, by a frequency translation component, the FDM signal to an SDM signal that includes multiple spatial layers, wherein the SDM signal mapped to the FDM signal compensates for a frequency error between the transmitter and the receiver; and means for providing the SDM signal to a MIMO transceiver. In some aspects, the means for the receiver to perform operations described herein may include, for example, one or more of communication manager 150, processing system 140, communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

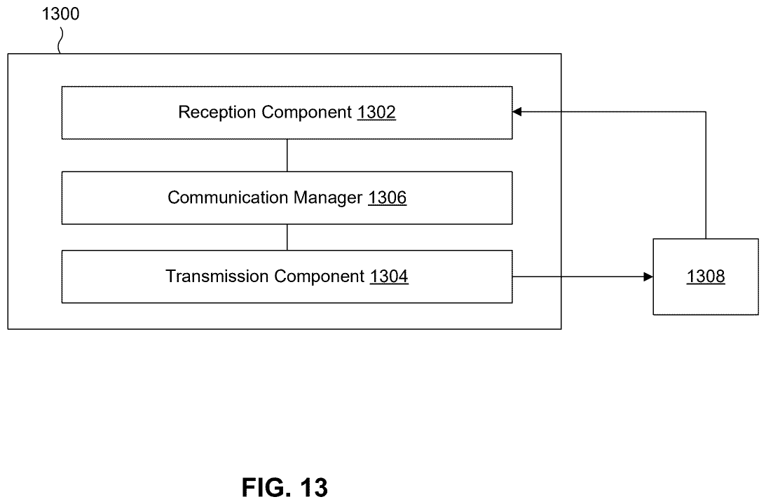

In some aspects, a transmitter (e.g., the UE 120 or the network node 110) includes means for providing, by a MIMO transceiver, an SDM signal that includes multiple spatial layers to a frequency translation component; means for mapping, by the frequency translation component, the SDM signal to an FDM signal; and means for transmitting, to a receiver over a wired infrastructure, the FDM signal, wherein the FDM signal transmitted over the wired infrastructure compensates for a frequency error between the transmitter and the receiver. In some aspects, the means for the transmitter to perform operations described herein may include, for example, one or more of communication manager 150, processing system 140, communication manager 155, processing system 145, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

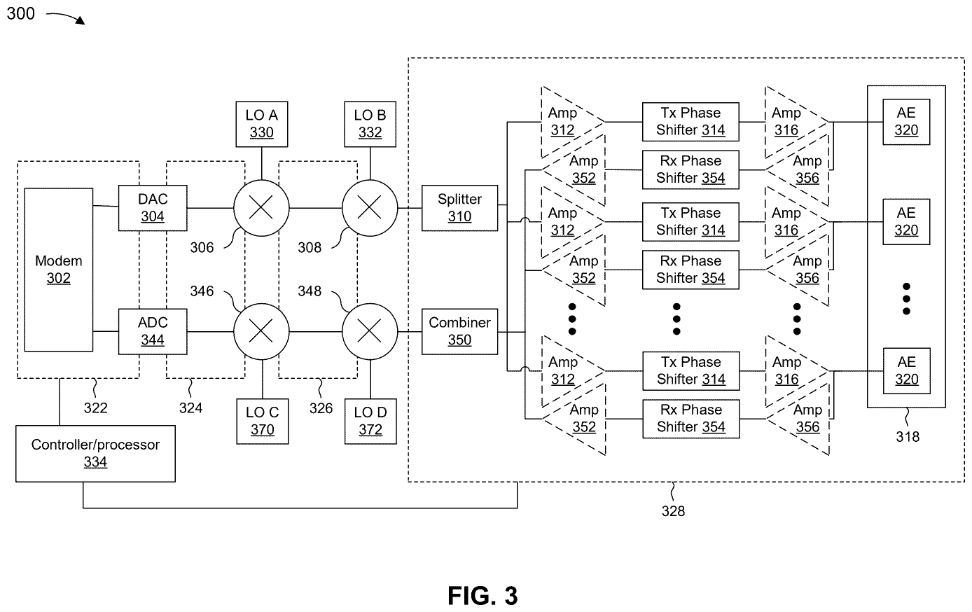

FIG. 3 is a diagram illustrating an example wireless transceiver architecture 300. In some aspects, architecture 300 may be implemented in a transmitting device (e.g., a first wireless communication device, a UE, or a network node) and/or a receiving device (e.g., a second wireless communication device, UE, or network node), as described herein.

As described herein, FIG. 3 is a diagram illustrating example hardware components of a wireless communication device in accordance with certain aspects of the disclosure. The illustrated components may include those that may be used for antenna element selection and/or for beamforming for transmission of wireless signals. There are numerous architectures for antenna element selection and implementing phase shifting, only one example of which is illustrated here. The architecture 300 includes a modem (modulator/demodulator) 302, a digital to analog converter (DAC) 304, a first mixer 306, a second mixer 308, and a splitter 310. The architecture 300 also includes multiple first amplifiers 312, multiple phase shifters 314, multiple second amplifiers 316, and an antenna array 318 that includes multiple antenna elements 320.

Transmission lines or other waveguides, wires, and/or traces are shown connecting the various components to illustrate how signals to be transmitted may travel between components. Reference numbers 322, 324, 326, and 328 indicate regions in the architecture 300 in which different types of signals travel or are processed. Specifically, reference number 322 indicates a region in which digital baseband signals travel or are processed, reference number 324 indicates a region in which analog baseband signals travel or are processed, reference number 326 indicates a region in which analog intermediate frequency (IF) signals travel or are processed, and reference number 328 indicates a region in which analog RF signals travel or are processed. The architecture also includes a local oscillator A 330, a local oscillator B 332, and a controller/processor 334.

Each of the antenna elements 320 may include one or more sub-elements for radiating or receiving RF signals. For example, a single antenna element 320 may include a first sub-element cross-polarized with a second sub-element that can be used to independently transmit cross-polarized signals. The antenna elements 320 may include patch antennas, dipole antennas, or other types of antennas arranged in a linear pattern, a two dimensional pattern, or another pattern. A spacing between antenna elements 320 may be such that signals with a desired wavelength transmitted separately by the antenna elements 320 may interact or interfere (e.g., to form a desired beam). For example, given an expected range of wavelengths or frequencies, the spacing may provide a quarter wavelength, half wavelength, or other fraction of a wavelength of spacing between neighboring antenna elements 320 to allow for interaction or interference of signals transmitted by the separate antenna elements 320 within that expected range.

The modem 302 processes and generates digital baseband signals and may also control operation of the DAC 304, first and second mixers 306, 308, splitter 310, first amplifiers 312, phase shifters 314, and/or the second amplifiers 316 to transmit signals via one or more or all of the antenna elements 320. The modem 302 may process signals and control operation in accordance with a communication standard such as a wireless standard discussed herein. The DAC 304 may convert digital baseband signals received from the modem 302 (and that are to be transmitted) into analog baseband signals. The first mixer 306 upconverts analog baseband signals to analog IF signals within an IF using a local oscillator A 330. For example, the first mixer 306 may mix the signals with an oscillating signal generated by the local oscillator A 330 to “move” the baseband analog signals to the IF. In some cases, some processing or filtering (not shown) may take place at the IF. The second mixer 308 upconverts the analog IF signals to analog RF signals using the local oscillator B 332. Similar to the first mixer, the second mixer 308 may mix the signals with an oscillating signal generated by the local oscillator B 332 to “move” the IF analog signals to the RF or the frequency at which signals will be transmitted or received. The modem 302 and/or the controller/processor 334 may adjust the frequency of local oscillator A 330 and/or the local oscillator B 332 so that a desired IF and/or RF frequency is produced and used to facilitate processing and transmission of a signal within a desired bandwidth.

In the illustrated architecture 300, signals upconverted by the second mixer 308 are split or duplicated into multiple signals by the splitter 310. The splitter 310 in architecture 300 splits the RF signal into multiple identical or nearly identical RF signals. In other examples, the split may take place with any type of signal, including with baseband digital, baseband analog, or IF analog signals. Each of these signals may correspond to an antenna element 320, and the signal travels through and is processed by amplifiers 312, 316, phase shifters 314, and/or other elements corresponding to the respective antenna element 320 to be provided to and transmitted by the corresponding antenna element 320 of the antenna array 318. In one example, the splitter 310 may be an active splitter that is connected to a power supply and provides some gain so that RF signals exiting the splitter 310 are at a power level equal to or greater than the signal entering the splitter 310. In another example, the splitter 310 is a passive splitter that is not connected to power supply and the RF signals exiting the splitter 310 may be at a power level lower than the RF signal entering the splitter 310.

After being split by the splitter 310, the resulting RF signals may enter an amplifier, such as a first amplifier 312, or a phase shifter 314 corresponding to an antenna element 320. The first and second amplifiers 312, 316 are illustrated with dashed lines because one or both of them might not be necessary in some aspects. In some aspects, both the first amplifier 312 and second amplifier 316 are present. In some aspects, neither the first amplifier 312 nor the second amplifier 316 is present. In some aspects, one of the two amplifiers 312, 316 is present but not the other. By way of example, if the splitter 310 is an active splitter, the first amplifier 312 may not be used. By way of further example, if the phase shifter 314 is an active phase shifter that can provide a gain, the second amplifier 316 might not be used.

The amplifiers 312, 316 may provide a desired level of positive or negative gain. A positive gain (positive dB) may be used to increase an amplitude of a signal for radiation by a specific antenna element 320. A negative gain (negative dB) may be used to decrease an amplitude and/or suppress radiation of the signal by a specific antenna element. Each of the amplifiers 312, 316 may be controlled independently (e.g., by the modem 302 or the controller/processor 334) to provide independent control of the gain for each antenna element 320. For example, the modem 302 and/or the controller/processor 334 may have at least one control line connected to each of the splitter 310, first amplifiers 312, phase shifters 314, and/or second amplifiers 316 that may be used to configure a gain to provide a desired amount of gain for each component and thus each antenna element 320.

The phase shifter 314 may provide a configurable phase shift or phase offset to a corresponding RF signal to be transmitted. The phase shifter 314 may be a passive phase shifter not directly connected to a power supply. Passive phase shifters might introduce some insertion loss. The second amplifier 316 may boost the signal to compensate for the insertion loss. The phase shifter 314 may be an active phase shifter connected to a power supply such that the active phase shifter provides some amount of gain or prevents insertion loss. The settings of each of the phase shifters 314 are independent, meaning that each can be independently set to provide a desired amount of phase shift or the same amount of phase shift or some other configuration. The modem 302 and/or the controller/processor 334 may have at least one control line connected to each of the phase shifters 314 and which may be used to configure the phase shifters 314 to provide a desired amount of phase shift or phase offset between antenna elements 320.

In the illustrated architecture 300, RF signals received by the antenna elements 320 are provided to one or more first amplifiers 356 to boost the signal strength. The first amplifiers 356 may be connected to the same antenna arrays 318 (e.g., for time division duplex (TDD) operations). The first amplifiers 356 may be connected to different antenna arrays 318. The boosted RF signal is input into one or more phase shifters 354 to provide a configurable phase shift or phase offset for the corresponding received RF signal to enable reception via one or more Rx beams. The phase shifter 354 may be an active phase shifter or a passive phase shifter. The settings of the phase shifters 354 are independent, meaning that each can be independently set to provide a desired amount of phase shift or the same amount of phase shift or some other configuration. The modem 302 and/or the controller/processor 334 may have at least one control line connected to each of the phase shifters 354 and which may be used to configure the phase shifters 354 to provide a desired amount of phase shift or phase offset between antenna elements 320 to enable reception via one or more Rx beams.

The outputs of the phase shifters 354 may be input to one or more second amplifiers 352 for signal amplification of the phase shifted received RF signals. The second amplifiers 352 may be individually configured to provide a configured amount of gain. The second amplifiers 352 may be individually configured to provide an amount of gain to ensure that the signals input to combiner 350 have the same magnitude. The amplifiers 352 and/or 356 are illustrated in dashed lines because they might not be necessary in some aspects. In some aspects, both the amplifier 352 and the amplifier 356 are present. In another aspect, neither the amplifier 352 nor the amplifier 356 are present. In other aspects, one of the amplifiers 352, 356 is present but not the other.

In the illustrated architecture 300, signals output by the phase shifters 354 (via the amplifiers 352 when present) are combined in combiner 350. The combiner 350 in architecture 300 combines the RF signal into a signal. The combiner 350 may be a passive combiner (e.g., not connected to a power source), which may result in some insertion loss. The combiner 350 may be an active combiner (e.g., connected to a power source), which may result in some signal gain. When combiner 350 is an active combiner, it may provide a different (e.g., configurable) amount of gain for each input signal so that the input signals have the same magnitude when they are combined. When combiner 350 is an active combiner, the combiner 350 may not need the second amplifier 352 because the active combiner may provide the signal amplification.

The output of the combiner 350 is input into mixers 348 and 346. Mixers 348 and 346 generally down convert the received RF signal using inputs from local oscillators 372 and 370, respectively, to create intermediate or baseband signals that carry the encoded and modulated information. The output of the mixers 348 and 346 are input into an ADC 344 for conversion to digital signals. The digital signals output from ADC 344 are input to modem 302 for baseband processing, such as decoding, de-interleaving, or similar operations.

The architecture 300 is given by way of example only to illustrate an architecture for transmitting and/or receiving signals. In some cases, the architecture 300 and/or each portion of the architecture 300 may be repeated multiple times within an architecture to accommodate or provide an arbitrary number of RF chains, antenna elements, and/or antenna panels. Furthermore, numerous alternate architectures are possible and contemplated. For example, although only a single antenna array 318 is shown, two, three, or more antenna arrays may be included, each with one or more of their own corresponding amplifiers, phase shifters, splitters, mixers, DACs, ADCs, and/or modems. For example, a single UE may include two, four, or more antenna arrays for transmitting or receiving signals at different physical locations on the UE or in different directions.

Furthermore, mixers, splitters, amplifiers, phase shifters and other components may be located in different signal type areas (e.g., represented by different ones of the reference numbers 322, 324, 326, 328) in different implemented architectures. For example, a split of the signal to be transmitted into multiple signals may take place at the analog RF, analog IF, analog baseband, or digital baseband frequencies in different examples. Similarly, amplification and/or phase shifts may also take place at different frequencies. For example, in some aspects, one or more of the splitter 310, amplifiers 312, 316, or phase shifters 314 may be located between the DAC 304 and the first mixer 306 or between the first mixer 306 and the second mixer 308. In one example, the functions of one or more of the components may be combined into one component. For example, the phase shifters 314 may perform amplification to include or replace the first and/or or second amplifiers 312, 316. By way of another example, a phase shift may be implemented by the second mixer 308 to obviate the need for a separate phase shifter 314. This technique is sometimes called local oscillator (LO) phase shifting. In some aspects of this configuration, there may be multiple IF to RF mixers (e.g., for each antenna element chain) within the second mixer 308, and the local oscillator B 332 may supply different local oscillator signals (with different phase offsets) to each IF to RF mixer.

The modem 302 and/or the controller/processor 334 may control one or more of the other components 304 through 372 to select one or more antenna elements 320 and/or to form beams for transmission of one or more signals. For example, the antenna elements 320 may be individually selected or deselected for transmission of a signal (or signals) by controlling an amplitude of one or more corresponding amplifiers, such as the first amplifiers 312 and/or the second amplifiers 316. Beamforming includes generation of a beam using multiple signals on different antenna elements, where one or more or all of the multiple signals are shifted in phase relative to each other. The formed beam may carry physical or higher layer reference signals or information. As each signal of the multiple signals is radiated from a respective antenna element 320, the radiated signals interact, interfere (constructive and destructive interference), and amplify each other to form a resulting beam. The shape (such as the amplitude, width, and/or presence of side lobes) and the direction (such as an angle of the beam relative to a surface of the antenna array 318) can be dynamically controlled by modifying the phase shifts or phase offsets imparted by the phase shifters 314 and amplitudes imparted by the amplifiers 312, 316 of the multiple signals relative to each other. The controller/processor 334 may be located partially or fully within one or more other components of the architecture 300. For example, the controller/processor 334 may be located within the modem 302 in some aspects.

As indicated above, FIG. 3 is provided as an example. Other examples may differ from what is described with regard to FIG. 3.

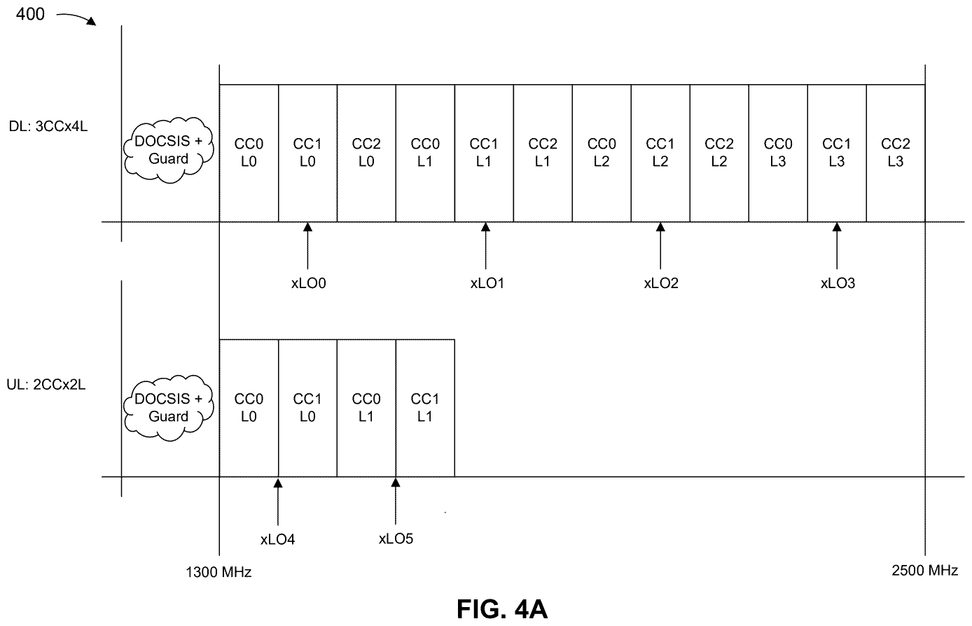

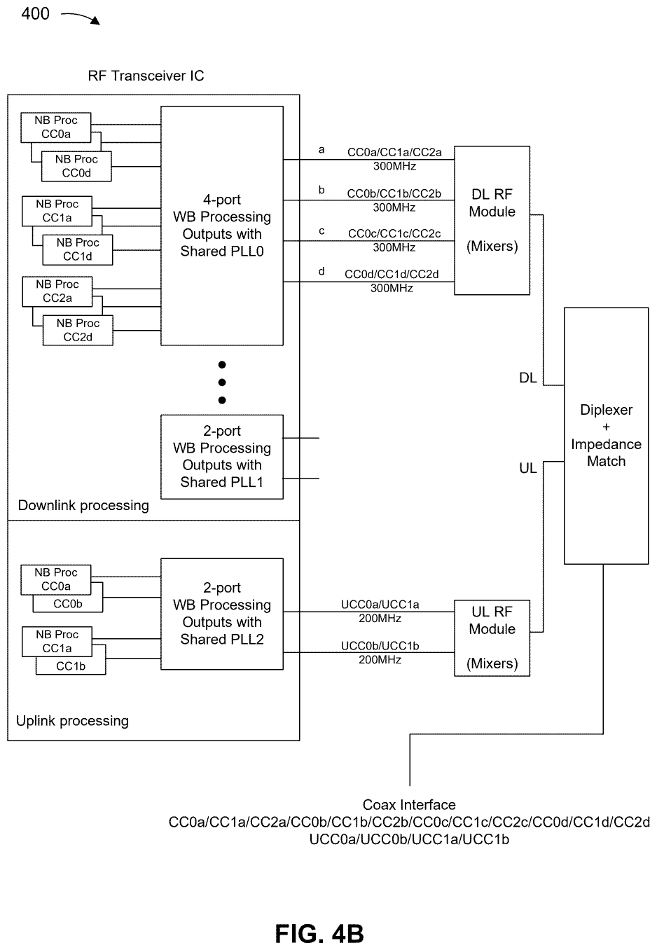

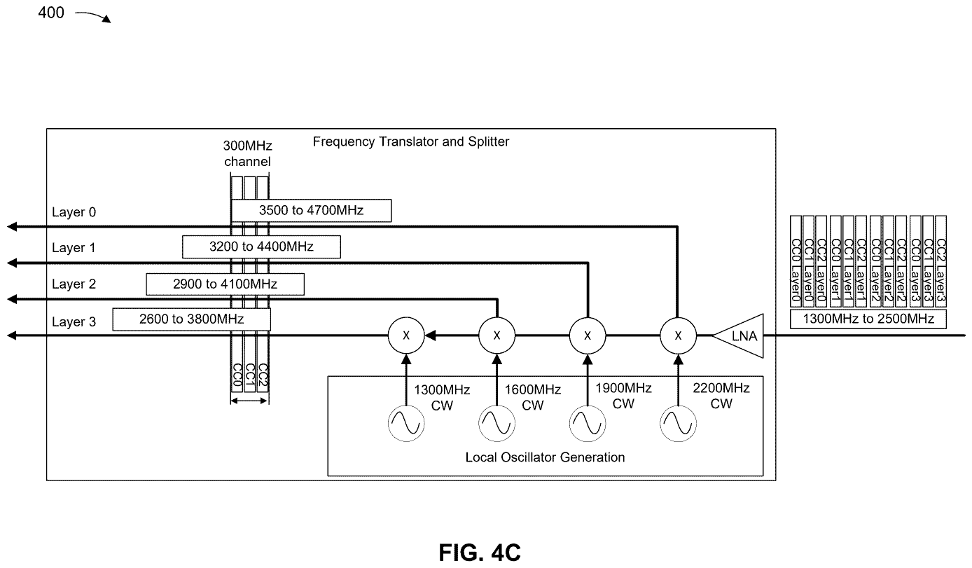

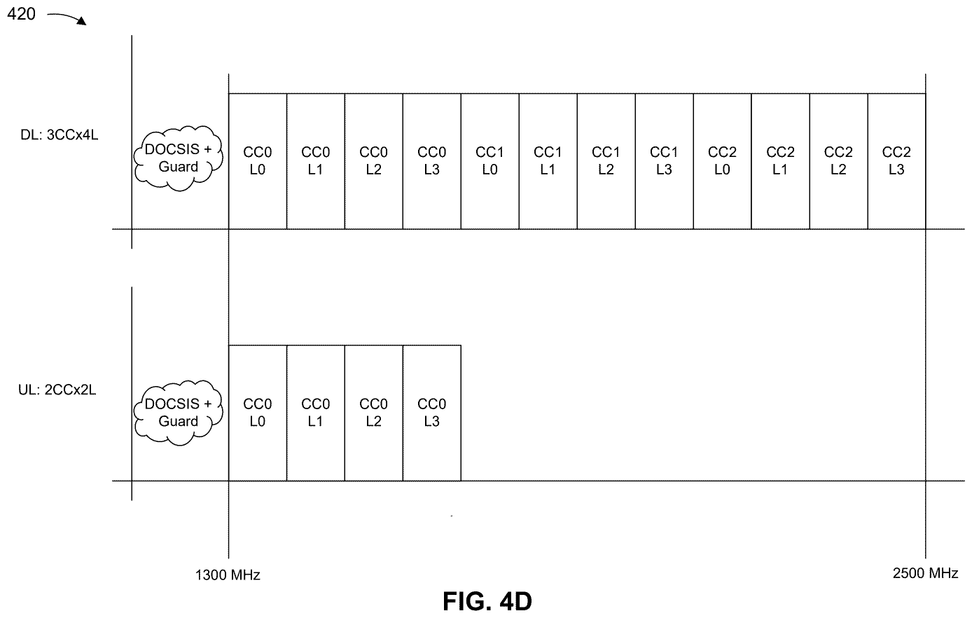

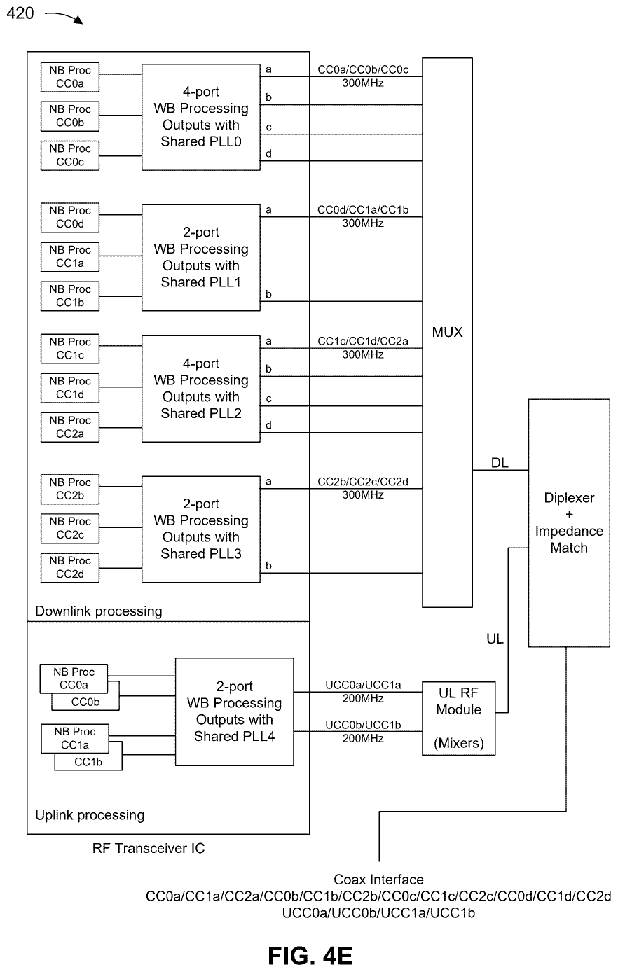

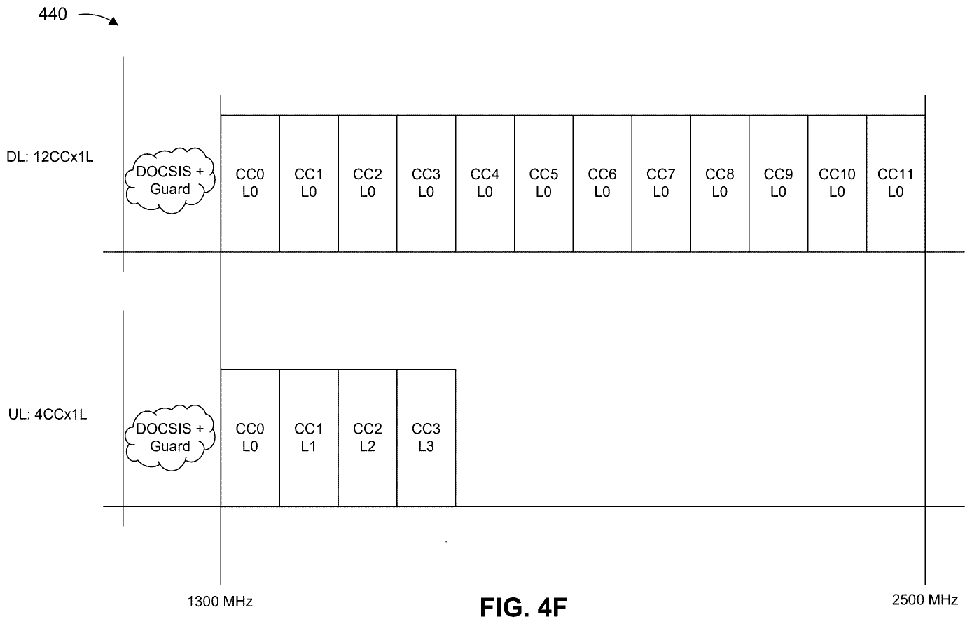

FIGS. 4A-4F are diagrams illustrating examples 400, 420, and 440 associated with FDM MIMO configurations to communicate over a cable infrastructure using a RAT. For example, as described herein, the FDM MIMO configurations may each arrange various MIMO layers of a component carrier in a frequency space (e.g., a frequency spectrum or a portion of a frequency spectrum) in a manner that leverages the capabilities and envelope of a wireless radio to enable effective transmission over a cable infrastructure and/or to feed a received signal associated with the FDM configuration as MIMO layers to a receiving component in an RF transceiver or wireless radio. In some aspects, as described herein, the FDM configurations may generally be used for downlink communication, where a network node or head-end may use the FDM configurations to transmit a downlink signal to a UE or CPE over a cable infrastructure, and for uplink communication, where a UE or CPE may use the FDM configurations to transmit an uplink signal to a network node or head-end over the cable infrastructure.

In some aspects, as described herein, the FDM configurations shown by examples 400, 420, and 440 may generally be used to arrange various MIMO layers of a component carrier in a frequency space. For example, as described herein, a component carrier may be mapped to one or more MIMO layers (e.g., transmission streams), where each MIMO layer may be referred to herein as a component carrier layer (CCL). For example, in an RoC, NRoC, or other system that uses a RAT to enable communication over a cable infrastructure, communication may be enabled using multiple component carriers, where the notation CCxLy may be used to refer to component carrier #x and MIMO layer #y with reference to a modem supporting the RoC or NROC system. As described in further detail herein, the FDM configurations shown by examples 400, 420, and 440 may each define a CCL placement within a frequency spectrum, where each CCL placement may offer different tradeoffs with respect to ease of implementation (e.g., with existing wireless radio designs or potential advances in wireless radio technology) versus performance and/or operational benefits. Furthermore, in some cases, different devices (e.g., network devices such as a network node, network elements such as amplifiers, splitters, and/or taps, and/or user devices such as UEs and/or CPEs) may have different capabilities and may support (or lack support for) one or more of the FDM configurations described herein. Accordingly, as described herein, devices that communicate over the cable infrastructure using one or more of the FDM configurations described herein may exchange signaling to coordinate negotiation of the FDM configuration to be used and/or to ensure interoperability between network devices, network elements, and/or user devices supporting the FDM configurations. For example, in some aspects, a network node and a UE/CPE may exchange capability signaling (e.g., online or offline via a preconfiguration or out-of-band signaling) to coordinate the FDM configuration to be used according to a protocol that may define band and/or carrier aggregation combinations to indicate the CCL placement and/or duplexing scheme, UE capabilities to specify carrier bandwidth, subcarrier spacing, and/or MCS capabilities for using a RAT to communicate over cable infrastructure, RRC configurations (e.g., the number, pattern, and/or placement of a DMRS when using a RAT to communicate over cable infrastructure, and/or one or more system information blocks (SIBs) or extensions to existing SIBs, such as SIB1).

In some aspects, as described herein, the FDM configurations shown by examples 400, 420, and 440 may each define an arrangement for a set of CCLs within a frequency space or frequency region associated with a cable frequency spectrum. For example, to ensure coexistence with DOCSIS (e.g., DOCSIS 3.1 and later versions), which occupies frequency spectrum from about 5 MHz to about 1200 MHz, the FDM configurations may start at a frequency of 1300 MHz or higher, with a guard band from about 1200 MHz to about 1300 MHz. For example, FIG. 4A, FIG. 4D, and FIG. 4F illustrate example FDM configurations that start at 1300 MHz and stop at 2500 MHz for RoC or NROC deployments that include 12 CCLs that each have a 100 MHz bandwidth. However, the starting frequency and the ending frequency of the CCLs provided herein are examples only, and an RoC or NROC deployment may occupy a different portion of the cable frequency spectrum. Furthermore, some aspects are described herein with a 100 MHz channel bandwidth to enable reusing NR techniques or other established RAT techniques and to maximize an envelope of existing wireless chipsets. Furthermore, although some aspects are described herein with respect to frequencies in FRI, similar techniques may be applied in other frequencies, such as FR2. Furthermore, other suitable channelizations (e.g., channel bandwidths other than 100 MHz may be used), and each FDM configuration described herein may implement TDD for uplink and downlink communication (e.g., using each CCL for uplink communication only or downlink communication only in a given TTI) or using FDD for uplink and downlink communication (e.g., using a first set of frequencies or CCLs for uplink communication and a second set of frequencies or CCLs for downlink communication, which may enable simultaneous uplink and downlink communication, or full-duplex communication, in a cable infrastructure that is not spectrum constrained).

In some aspects, as described herein, a wireless radio or wireless chipset that supports communication over a cable infrastructure may generally have various minimum capabilities. For example, in some aspects, the FDM configurations described herein may be used by a device (e.g., a UE/CPE or network node) with wireless communication hardware that supports at least 4 layers on a downlink, at least 2 layers on an uplink, one or more 4-port wideband processing units, one or more 2-port wideband processing units, and support for a maximum bandwidth of at least 300 MHz on a single port of a wideband processing unit. However, these capabilities are exemplary, and wireless communication hardware may have more limited capabilities or greater capabilities (e.g., support for 8 downlink layers and 4 uplink layers, and an 8-port wideband processing unit with a 400 MHz bandwidth on a single port). Furthermore, in some cases, an FDM configuration may use mixers that are external to an RF transceiver for uplink and downlink communication (e.g., as shown in FIG. 4B), or an FDM configuration use operations that are internal to the RF transceiver for downlink communication and use a mixer external to the RF transceiver for uplink communication (e.g., as shown in FIG. 4E). Accordingly, while FIGS. 4A-4F provide example FDM configurations and hardware implementations to achieve a frequency positioning for various CCLs, other suitable hardware implementations may be used and the specific choice of FDM configuration to be used may depend on the FDM configuration(s) supported by a UE/CPE and/or a network node and other factors. Furthermore, techniques for using a RAT to communicate over a cable infrastructure (e.g., as defined in one or more specifications or standards, protocols, and/or procedures) may be generic in supporting any or all of the FDM configurations.

For example, referring to FIG. 4A, example 400 illustrates a first FDM configuration in which various MIMO layers are spaced uniformly within the cable frequency spectrum (e.g., using external oscillators, as shown in FIG. 4C and described in more detail elsewhere herein). For example, FIG. 4A illustrates a frequency arrangement for downlink communication that uses three component carriers across four downlink layers, where three component carriers (CC0-CC2) each include four MIMO layers (L0-L3). Accordingly, for downlink communication, CCLs that are associated with the same MIMO layer are contiguous or adjacent within the frequency spectrum such that the MIMO layers are uniformly spaced in frequency. For example, the first three CCLs correspond to the first MIMO layer for the various component carriers (CC0L0, CC1L0, CC2L0), the next three CCLs correspond to the second MIMO layer for the various component carriers (CC0L1, CC1L1, CC2L1), and so on. As described herein, the first FDM configuration shown in FIG. 4A may be amenable to using external local oscillators to space the MIMO layers uniformly, and aims to make RoC or NRoC operation transparent to the wireless radio or wireless chipset (e.g., to reuse existing wireless radios or wireless chipsets for communication over cable infrastructure). For example, as shown in FIG. 4A, a first local oscillator (xLO0) may be configured to receive a signal at a center frequency associated with a first MIMO layer (L0), a second local oscillator (xLO1) may be configured to receive a signal at a center frequency associated with a second MIMO layer (L1), and so on. Furthermore, a similar FDM configuration may be used for uplink communication. For example, FIG. 4A illustrates an uplink configuration with two component carriers and one layer, where the two CCLs corresponding to the first (only) layer are aligned with the first two downlink CCLs. In general, the FDM configuration shown in FIG. 4A may have more external translations than the FDM configurations shown in FIGS. 4D-4F, but may be relatively easier to implement by reusing existing wireless radios or wireless chipsets.

In some aspects, as shown in FIG. 4B, an example hardware implementation for the FDM configuration shown in FIG. 4A may include an RF transceiver integrated circuit that includes a downlink processing unit coupled to a downlink external RF module and an uplink processing unit coupled to an uplink external RF module. In some aspects, the downlink external RF module may include one or more mixers for processing a received downlink signal to provide a corresponding set of signals to the downlink processing unit, and the uplink external RF module may include one or more mixers for generating an uplink signal based on a set of signals received from the uplink processing unit. For example, as shown, the downlink processing unit may include various narrowband processing units that are each configured to process a received signal associated with a respective CCL, and the various signals associated with the CCLs may be provided to the narrowband processing units via a 4-port wideband processing unit that generates a set of outputs with a shared PLL. For example, a first port (shown as line a) carries three CCLs (CC0a, CC1a, CC2a) that each have a bandwidth of 100 MHz for an aggregated bandwidth of 300 MHz and are all associated with the same layer (e.g., CC0L0-CC2L0). Similarly, a second port (shown as line b) carries three CCLs associated with a second layer, a third port (shown as line c) carries three CCLs associated with a third layer, and a fourth port (shown as line d) carries three CCLs associated with a fourth layer. The various CCLs are processed using the DL external RF module, which uses external oscillators to space the MIMO layers uniformly in the frequency space. For example, FIG. 4C illustrates an example frequency translator and splitter that may be included in the DL external RF module, where the frequency translator and splitter includes a low noise amplifier (LNA) and four local oscillators to space four MIMO layers uniformly in a frequency space. As shown in FIG. 4B, the downlink signal may be received via a coaxial cable interface, and then passed to a diplexer and impedance match component, which provides the downlink signal to the DL external RF module. The downlink signal is provided to the frequency translator and splitter shown in FIG. 4C, starting at the LNA, and the DL external RF module provides the various CCLs to the 4-port wideband processing unit. Furthermore, as shown in FIG. 4B, a similar (reverse) approach may be used for uplink communications, where uplink signals generated by narrowband processing units may be provided to the 2-port wideband processing unit, which provides the various CCLs to the UL external RF module. The uplink CCLs are then provided to the diplexer and impedance match component, which transmits the uplink CCLs via the coaxial cable interface. In some aspects, as described herein, the downlink and uplink external RF components (or a subset thereof) may be shared or separate.

Additionally, or alternatively, referring to FIG. 4D, example 420 illustrates a second FDM configuration in which various MIMO layers associated with the same component carrier are arranged contiguously (adjacent) within the cable frequency spectrum. For example, FIG. 4D illustrates a frequency arrangement for downlink communication that uses three component carriers across four downlink layers, where the four MIMO layers of the first component carrier (CC0L0-CC0L3), the four MIMO layers of the second component carrier (CC1L0-CC1L3), and the four MIMO layers of the third component carrier (CC2L0-CC2L3) are contiguous within the cable frequency spectrum. Similarly, FIG. 4D illustrates a frequency arrangement for uplink communication that uses two component carriers across two uplink layers, where the two MIMO layers of the first component carrier (CC0L0-CC0L1) and the two MIMO layers of the second component carrier (CC1L0-CC1L1) are all contiguous within the cable frequency spectrum. In this way, one or more component carriers can be enabled or disabled while maintaining a contiguous frequency allocation within the cable frequency spectrum. Accordingly, the second FDM configuration shown in FIG. 4D may allow different bandwidth modes of inline amplifiers to be used for communication over the cable infrastructure and may enable capabilities to be scaled up (e.g., to higher spectrum) as newer generations of equipment are developed (e.g., including network nodes, amplifiers, CPEs, or the like). Furthermore, because all MIMO layers associated with a single component carrier are adjacent in the cable frequency spectrum, the MIMO layers associated with a component carrier experience similar pathloss characteristics. In this way, on a shared cable drop (e.g., where a single cable drop is shared by various CPEs in different locations, such as different homes or buildings), a network node can schedule UEs/CPEs that are closer to the network node on component carriers in a higher region of the cable frequency spectrum and UEs/CPEs that are farther from the network node on component carriers in a lower region of the cable frequency spectrum (e.g., based on cable attenuation increasing with frequency). Furthermore, depending on a hardware implementation, the second FDM configuration may have fewer frequency translations relative to the hardware implementation shown in FIGS. 4B-4C for the first FDM configuration shown in FIG. 4A.

In some aspects, as shown in FIG. 4E, an example hardware implementation for the FDM configuration shown in FIG. 4D may include an RF transceiver integrated circuit that includes an uplink processing unit coupled to an uplink external RF module, and internal multiplexing capabilities of the RF transceiver may be used to enable different MIMO layers of a component carrier to be FDMed adjacent to one another (e.g., via a modem, narrowband processing, or transceiver). For example, FIG. 4E illustrates an example hardware implementation that uses internal circuitry (e.g., multiple PLLs) within the downlink processing unit of the RF transceiver to eliminate the need for an external mixer for downlink communication. For example, based on signals received from various narrowband processing units, a first 4-port wideband processing unit with a first shared PLL (PLL0) may generate the first three MIMO layers of a first component carrier, a first 2-port wideband processing unit with a second shared PLL (PLL1) may generate the fourth MIMO layer of the first component carrier and the first two MIMO layers of a second component carrier, a second 4-port wideband processing unit with a third shared PLL (PLL2) may generate the third and fourth MIMO layers of the second component carrier and the first MIMO layer of the third component carrier, and a second 2-port wideband processing unit with a fourth shared PLL (PLL3) may generate the last three MIMO layers of the third component carrier. On an uplink path, an external mixer may be used in the uplink external RF module to FDM multiplex the uplink signal as an example, but the techniques shown for using the internal multiplexing capabilities of the RF transceiver may be applied to the uplink path, the downlink path, or both the uplink and the downlink path depending on device capabilities.

Additionally, or alternatively, referring to FIG. 4F, example 440 illustrates a third FDM configuration in which the cable frequency spectrum is treated as an amalgamation of 1-layer component carriers. For example, FIG. 4F illustrates a frequency arrangement for downlink communication that uses twelve component carriers across one downlink layer, and a frequency arrangement for uplink communication that uses four component carriers across one uplink layer. The third FDM configuration shown by example 440 may be simpler than the FDM configurations shown by examples 400 and 420, but may be dependent on hardware and/or software capabilities to work on both a network node and a UE/CPE. For example, the third FDM configuration that treats the cable frequency spectrum as an amalgamation of 1-layer component carriers may depend on support for a large number of component carriers (e.g., defining encoding and/or decoding requirements, because codeblocks are restricted to a component carrier) and may depend on suitably handling a state per component carrier (e.g., frequency tracking, time tracking, or the like, which may impose software, memory, and/or hardware constraints on existing wireless radios or wireless chipsets). However, the third FDM configuration shown by example 440 may require the fewest (potentially no) external translations. In addition, from a hardware cost perspective, the second FDM configuration shown by example 420 and the third FDM configuration shown by example 440 may have a similar cost to each other, and a lower cost than the FDM configuration shown by example 400. In addition, the third FDM configuration shown by example 440 may enable optimal scheduling in the frequency domain (e.g., with reference to characteristics of the cable frequency spectrum or cable infrastructure, because individual CCLs can be activated or deactivated at a higher granularity). Furthermore, the hardware implementation shown in FIG. 4E may support the FDM configuration where each component carrier is associated with one MIMO layer, where the various single-layer component carriers may be FDMed by the modem, the narrowband/wideband processing units, and/or other components of the RF transceiver.

As indicated above, FIGS. 4A-4F are provided as an example. Other examples may differ from what is described with regard to FIGS. 4A-4F.

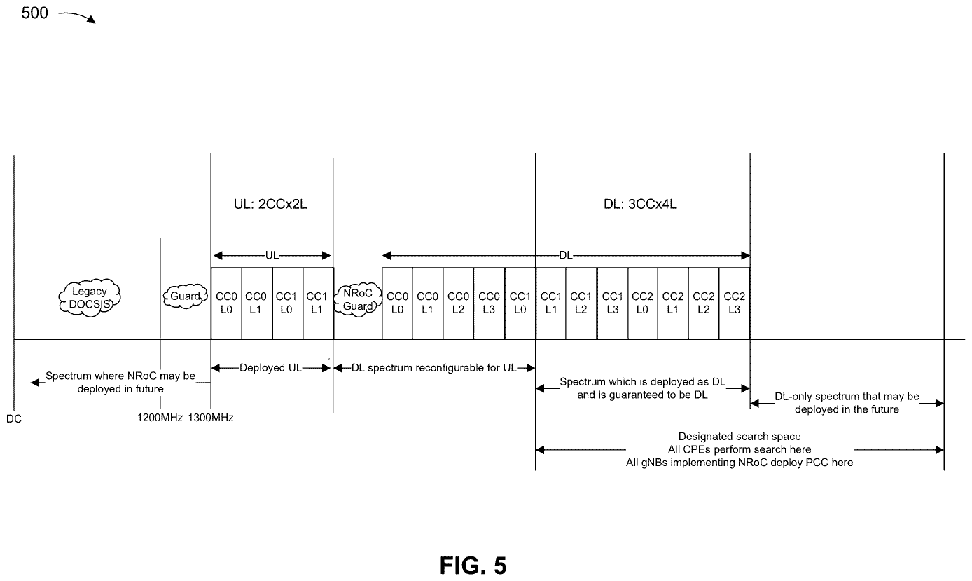

FIG. 5 is a diagram illustrating an example 500 associated with an FDD configuration to communicate over a cable infrastructure using a RAT. For example, as described herein, a set of CCLs that are used for downlink and uplink communication over a cable infrastructure may generally be deployed in an FDM configuration, where all CCLs that are associated with the same MIMO layer are contiguous or adjacent in frequency, all CCLs that are associated with the same component carrier are contiguous or adjacent in frequency, or all component carriers are associated with one layer.

Furthermore, as described herein, the CCLs may be deployed in a TDD configuration or an FDD configuration. For example, in a TDD configuration, each CCL is either used for uplink communication or for downlink communication in a particular TTI (e.g., according to a TDD configuration pattern that defines uplink TTIs, downlink TTIs, and/or flexible TTIs that can be configured for uplink, downlink, and/or sub-band full-duplexing). In some aspects, to support a TDD configuration, one or more band combinations within the cable frequency spectrum and/or appropriate UE capabilities may be defined (e.g., to specify frequency bands or frequency regions within the cable frequency spectrum that are deployed in the TDD mode and to specify UE capabilities and/or parameters for communicating in the TDD mode).

Additionally, or alternatively, one or more frequency bands or frequency regions (e.g., sets of frequencies) in the cable frequency spectrum may be deployed in an FDD mode (e.g., to improve uplink performance, particularly in view of wireless chipsets typically being uplink-limited). For example, in an FDD mode, one or more frequency regions or sets of frequencies may be configured for downlink communication, and one or more frequency regions or sets of frequencies may be configured for uplink communication. In this way, a UE or CPE may transmit uplink data in the uplink frequency region(s) and simultaneously receive downlink data in the downlink frequency region(s). In some aspects, to support an FDD configuration, one or more band combinations within the cable frequency spectrum and/or appropriate UE capabilities may be defined (e.g., to specify frequency bands or frequency regions within the cable frequency spectrum that are deployed in the FDD mode and to specify UE capabilities and/or parameters for communicating in the FDD mode). For example, FIG. 5 illustrates an example FDD deployment where a first frequency region is deployed in an uplink mode, with 4 CCLs (e.g., 2 uplink component carriers across 2 MIMO layers) and a second frequency region is deployed in a downlink mode, with 12 CCLs (e.g., 3 downlink component carriers across 4 MIMO layers). Furthermore, as shown in FIG. 5, a guard band may be provided between the uplink frequency region and the downlink frequency region to mitigate interference.

In some aspects, as described herein, the overall cable frequency spectrum that is available for RoC or NROC deployments may support TDD and FDD deployments (e.g., in different frequency regions, similar to frequency bands that are designated to be used in a TDD mode or an FDD mode for wireless communication). Accordingly, because the cable frequency spectrum may support TDD and FDD deployments and/or may be configurable or reconfigurable in a TDD mode or an FDD mode, the cable frequency spectrum may include one or more dedicated or designated frequency regions that are guaranteed or reserved to always being deployed for downlink communication, regardless of whether the RoC or NROC system is deployed in an FDD mode, a TDD mode, or a combination thereof. For example, in some aspects, the frequency regions that are guaranteed or reserved to always being deployed for downlink communication may be defined according to one or more band combinations, and may correspond to a frequency region that contains a default UE search space and a frequency region that supports camping by UEs and/or CPEs based on decoding broadcast information (e.g., a master information block (MIB) and/or one or more SIBs) and determining cell capabilities. Furthermore, because uplink communication may have better performance at lower frequencies, the downlink-only frequency region that contains the default UE search space may be located in an upper region of the downlink-only spectrum. For example, in the FDD deployment shown in FIG. 5, CC0L0 through CC1L0 are allocated in a portion of the cable frequency spectrum that is deployed as downlink and reconfigurable in an uplink mode, and CC1L1 through CC2L3 are allocated in a portion of the cable frequency spectrum that is deployed as downlink and not reconfigurable in an uplink mode (e.g., guaranteed to always be downlink). In addition, there may be unused higher frequencies or higher frequency regions that are designated downlink-only. Accordingly, the default UE search space may be contained within the downlink-only frequency regions to ensure that any changes to the uplink or downlink deployments do not impact the location of the default UE search space. Furthermore, as shown in FIG. 5, any network nodes that implement an RoC or NROC system may deploy a primary component carrier (PCC) within the downlink-only frequency regions. Furthermore, as shown in FIG. 5, the downlink-only frequency regions are located at higher frequencies than the downlink frequency region that is reconfigurable as uplink.

As indicated above, FIG. 5 is provided as an example. Other examples may differ from what is described with regard to FIG. 5.

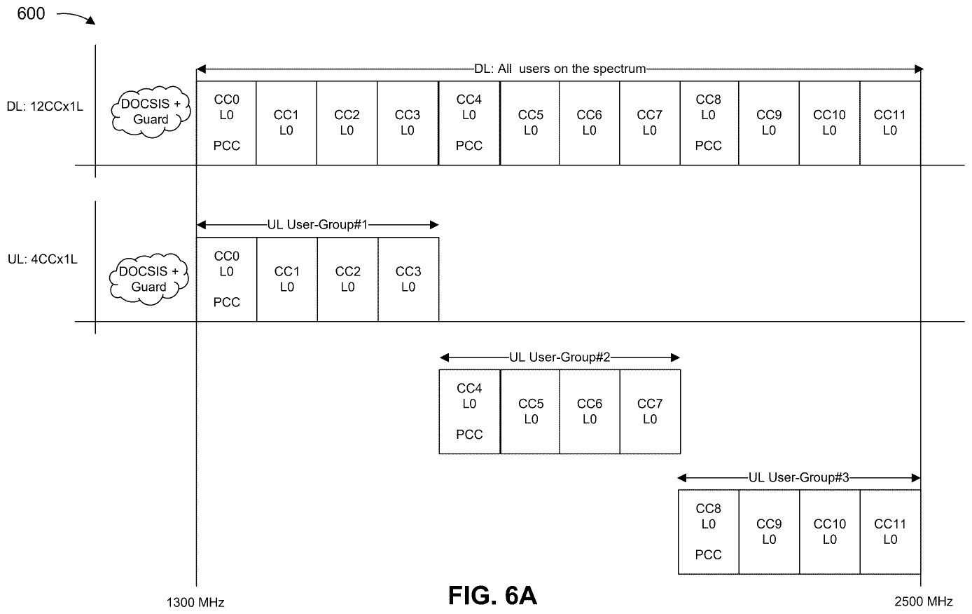

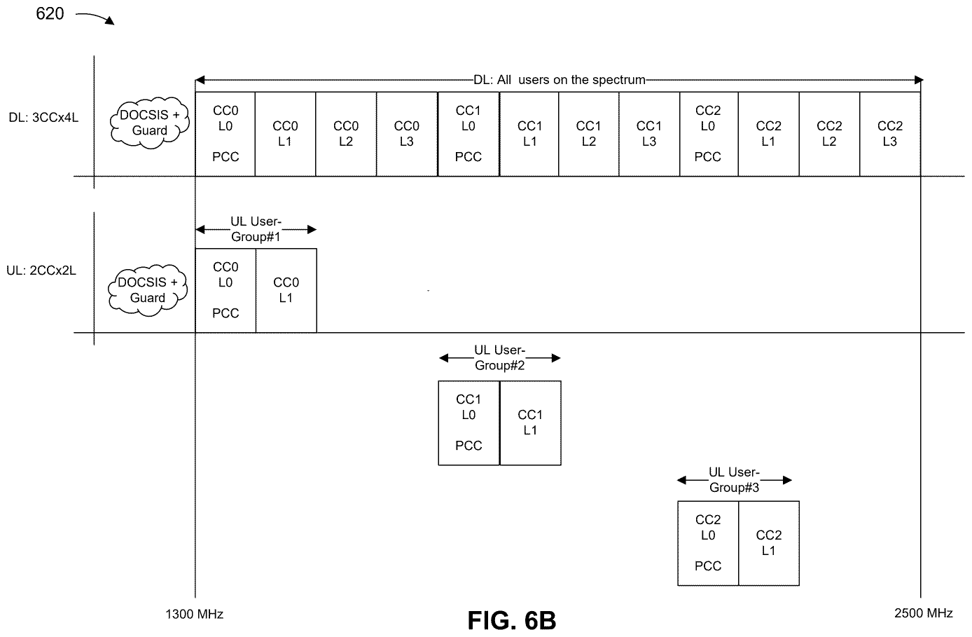

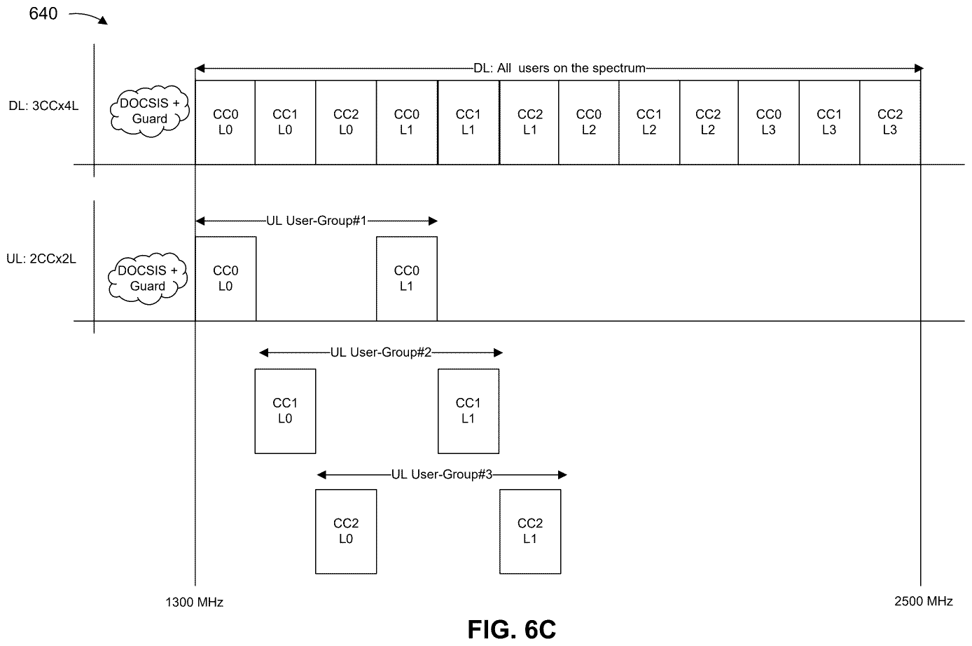

FIGS. 6A-6C are diagrams illustrating examples 600, 620, and 640 associated with TDD configurations to communicate over a cable infrastructure using a RAT. As described herein, an RoC or NROC system may be deployed using wireless radios, wireless chipsets, RF transceivers, and/or other hardware, software, and/or protocol-based techniques that are designed for wireless communication. Accordingly, one challenge that may arise in an RoC or NRoC system is that the resources used for wireless communication tend to be constrained in an uplink envelope relative to a downlink envelope, particular at a UE. For example, some wireless chipsets may support 3 component carriers across 4 MIMO layers on a downlink, but only 2 component carriers across 2 MIMO layers on an uplink. As a result, in a TDD deployment where frequency resources are used for uplink communication and downlink communication in different TTIs, the frequency spectrum deployed in a TDD mode may be underutilized during an uplink phase of the duty cycle. Accordingly, in some aspects, utilization of frequency spectrum deployed in a TDD mode may be increased by appropriate network configurations, with varying improvements to the spectrum utilization and tradeoffs relative to single-user capacity.

For example, FIG. 6A illustrates an example 600 of a multi-user configuration to increase utilization of cable frequency spectrum in uplink TTIs, when deployed in a TDD mode. In example 600, the multi-user configuration is provided in a frequency region that is configured in a TDD mode, where a downlink configuration includes 12 CCLs that are deployed as 12 component carriers across one layer (e.g., using the FDM configuration shown in FIG. 4F). Furthermore, the frequency region is associated with an uplink configuration that includes 4 CCLs that are deployed as 4 component carriers across one layer. Accordingly, to increase spectrum utilization, the 12 CCLs that support all users for downlink communication may be partitioned into 4 CCLs for a first user group, 4 CCLs for a second user group, and 4 CCLs for a third user group, whereby the full frequency spectrum is utilized (or available to be utilized) during uplink phases of the TDD duty cycle.

Alternatively, FIG. 6B illustrates another example 620 of a multi-user configuration to increase utilization of cable frequency spectrum deployed in a TDD mode during uplink TTIs. In example 620, the multi-user configuration is provided in a frequency region that is configured in a TDD mode, where a downlink configuration includes 12 CCLs that are deployed as 3 component carriers across four layers (e.g., using the FDM configuration shown in FIG. 4D, where all MIMO layers of a component carrier are contiguous or adjacent in spectrum). Additionally, or alternatively, as shown by example 640 in FIG. 6C, the downlink configuration may use the FDM configuration shown in FIG. 4A, where all component carriers associated with the same MIMO layer are contiguous or adjacent in spectrum. Furthermore, in examples 620 and 640, the frequency region is associated with an uplink configuration that includes 4 CCLs that are deployed as 2 component carriers across 2 layers. Accordingly, to increase spectrum utilization, the 12 CCLs that support all users for downlink communication may be partitioned into 2 CCLs for a first user group, 2 CCLs for a second user group, and 2 CCLs for a third user group, where the uplink CCLs associated with each user group include two MIMO layers associated with the same component carrier. For example, the two CCLs associated with each user group are contiguous in FIG. 6B, and the two CCLs associated with each user group are non-contiguous in FIG. 6C (e.g., based on the FDM configuration). In this way, the utilization of the frequency spectrum is increased (or available to be increased) by up to 50% system-wide during uplink phases of the TDD duty cycle relative to a single-user mode (e.g., 6 CCLs are used during uplink phases compared to 4 CCLs in a single-user mode). However, the uplink allocation is limited to the minimum of the number of downlink and uplink layers (e.g., 2 layers in the illustrated example), because correspondence is preserved to the number of component carriers. Furthermore, peak single user throughput decreases by 50% relative to a single-user mode (e.g., 2 CCLs are used by each user group during uplink phases compared to 4 CCLs in a single-user mode). In some cases, some of these limitations may be overcome through suitable configurations (e.g., for users in the first uplink user group, with a PCC at CC0, additional uplink capacity may be configured by configuring CC1 and/or CC2 as uplink SCCs).

In some aspects, in the multi-user TDD configurations shown in FIGS. 6A-6C, a network node may designate one CCL associated with each user group as a PCC (e.g., a CCL associated with a lowest frequency). For example, in the example 600 shown in FIG. 6A, the network node may designate CC0L0, CC4L0, and CC8L0 as a PCC. Alternatively, in the example 620 shown in FIG. 6B and/or the example 640 shown in FIG. 6C, the network node may designate CC0L0, CC1L0, and CC2L0 as a PCC. In some aspects, the network node may configure SSBs in the CCLs that are designated to be a PCC to be cell-defining SSBs that are located on one or more global synchronization channel number (GSCN) frequency locations. On all other CCLs, SSBs can be configured at any location and do not need to be on GSCN locations, and a MIB can be reserved or barred on CCLs other than the CCLs designated to be a PCC. Furthermore, a UE or CPE may camp on any of the CCLs that are designated to be a PCC, and a network node may trigger a handover of a CPE or UE in accordance with one or more criteria for redistributing UEs or CPEs to other PCCs. In such cases, the network node may configure the UE or CPE with SCCs (e.g., CC1L0 through CC3L0 in user group 1 in FIG. 6A, or CC0L0 in FIGS. 6B-6C) after the PCC has been reassigned.

As indicated above, FIGS. 6A-6C are provided as an example. Other examples may differ from what is described with regard to FIGS. 6A-6C.

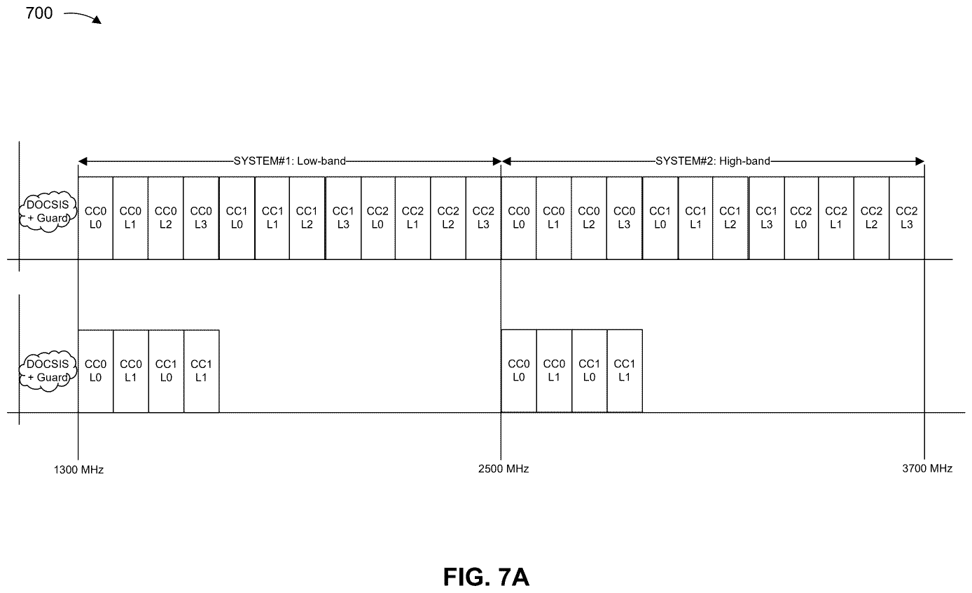

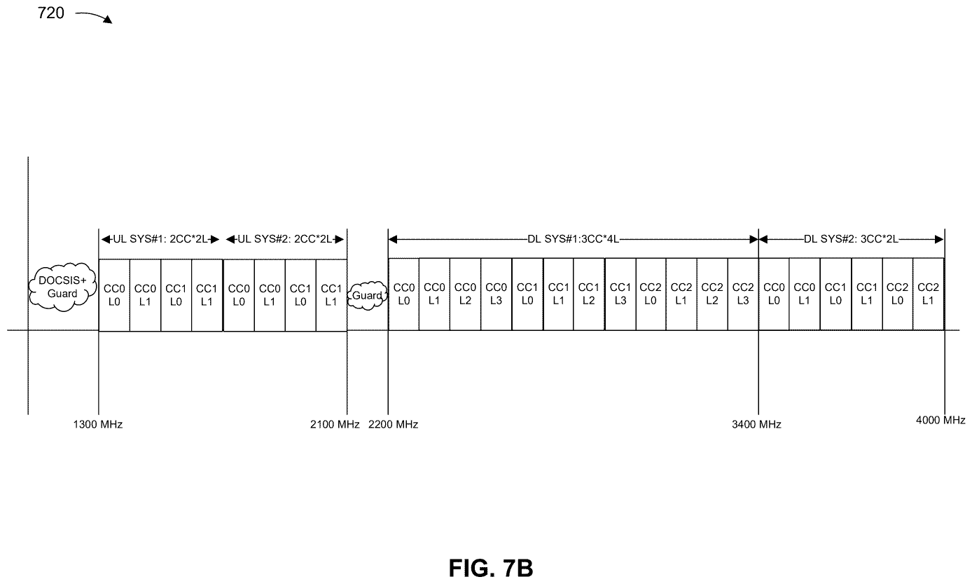

FIGS. 7A-7B are diagrams illustrating examples 700 and 720 associated with multi-system operations to communicate over a cable infrastructure using a RAT. As described herein, an RoC or NRoC system may be deployed using wireless radios, wireless chipsets, RF transceivers, and/or other hardware, software, and/or protocol-based techniques that are designed for wireless communication. Accordingly, one challenge that may arise in an RoC or NRoC system is that the devices used for wireless communication tend to be constrained in terms of envelope support. However, the cable infrastructure may have access to additional frequency spectrum than the wireless chipsets are capable of supporting. Accordingly, in some aspects, utilization of cable frequency spectrum may be increased by deploying multiple systems (or cells) on the cable frequency spectrum.

For example, in some aspects, mobility procedures may be used to transition or handover UEs or CPEs from one system to another in a manner that exploits the pathloss characteristics of the cable frequency spectrum or cable infrastructure. For example, a UE or CPE that is located relatively close to a network node or head-end may report a relatively high RSRP measurement to the network node, which may result in the network node triggering a handover to another system that is operating in a higher frequency region within the cable frequency spectrum (e.g., a high-band system). Similarly, a UE or CPE that is located relatively farther away from a network node or head-end may report a relatively low RSRP measurement to the network node, which may result in the network node triggering a handover to another system that is operating in a lower frequency region within the cable frequency spectrum (e.g., a low-band system). Furthermore, similar load balancing functions may be applied across CCLs that are covered by a single system. For example, a network node may schedule one or more UEs or CPEs that are located closer to the network node (e.g., report higher RSRP measurements) on CCLs that are in a higher frequency region, and may schedule one or more UEs or CPEs that are located farther from the network node (e.g., report lower RSRP measurements) on CCLs that are in a lower frequency region. Furthermore, multi-system operation may be supported with any of the FDM configurations described herein, and may be supported in TDD and FDD deployments.

For example, FIG. 7A illustrates an example 700 of multi-system operations in a TDD deployment, where a first TDD system is deployed in a low-band (lower frequency region) and a second TDD system is deployed in a high-band (higher frequency region). Additionally, or alternatively, FIG. 7B illustrates an example 720 of multi-system operations in an FDD deployment, where a first FDD system includes a first uplink system with 4 CCLs deployed as 2 component carriers across 2 MIMO layers and a first downlink system with 12 CCLs deployed as 3 component carriers across 4 MIMO layers. Furthermore, as shown, a second FDD system includes a second uplink system with 4 CCLs deployed as 2 component carriers across 2 MIMO layers and a second downlink system with 6 CCLs deployed as 3 component carriers across 2 MIMO layers. In example 720, the second downlink system may have a lower capability (e.g., fewer CCLs) than the first downlink system, which may allow the network to fit multiple systems within an allocated portion of the cable frequency spectrum (e.g., a 4 GHz allocation). Furthermore, although FIG. 7B illustrates the downlink system with the higher capability (e.g., more CCLs) in a lower frequency region than the downlink system with the lower capability, the downlink system with the higher capability may be deployed in a higher frequency region than the downlink system with the lower capability. Furthermore, a similar technique (e.g., varying numbers of CCLs) may be applied to multi-system operations in a TDD mode.

As indicated above, FIGS. 7A-7B are provided as an example. Other examples may differ from what is described with regard to FIGS. 7A-7B.

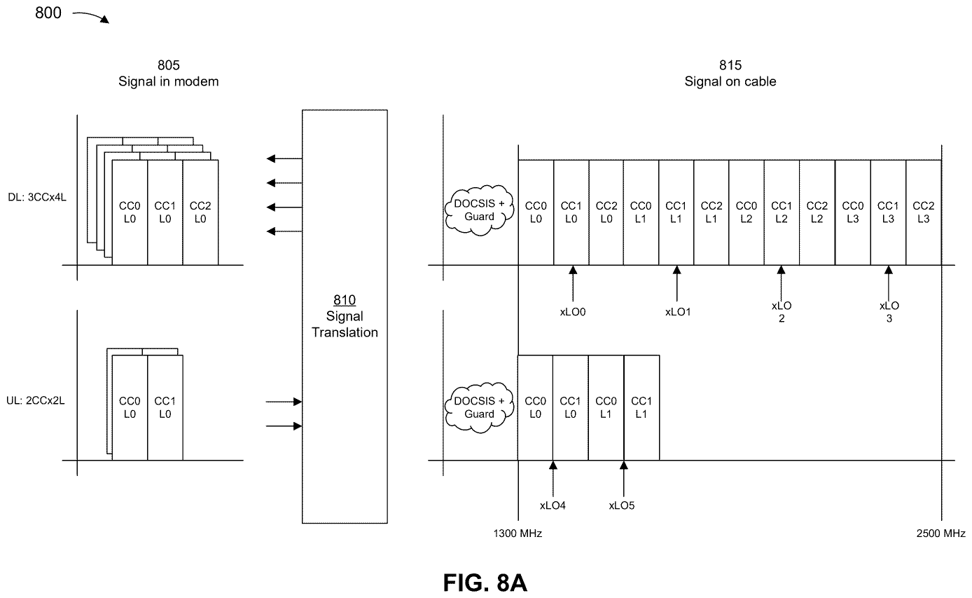

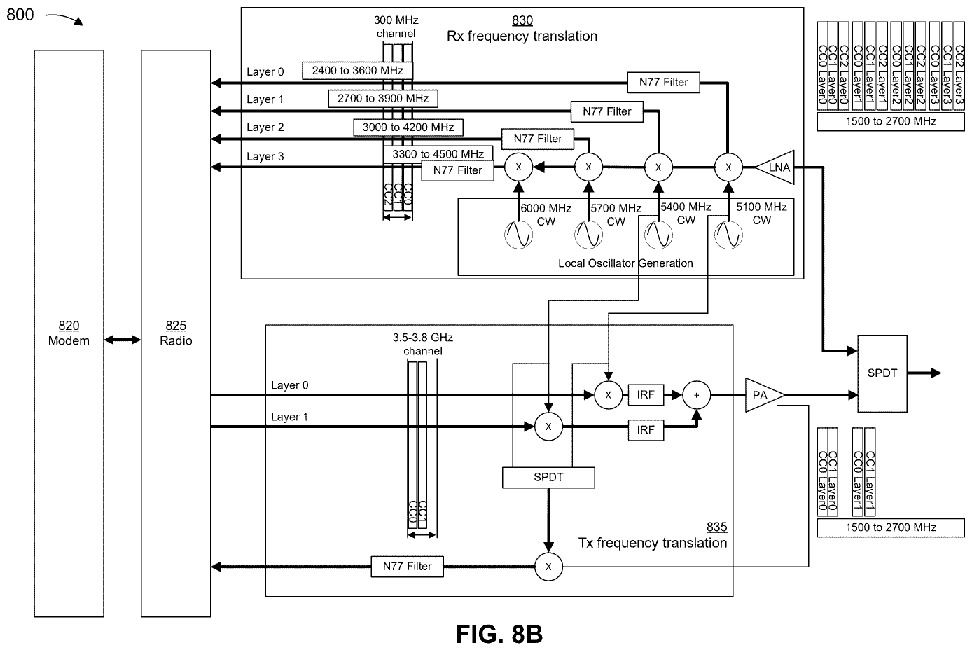

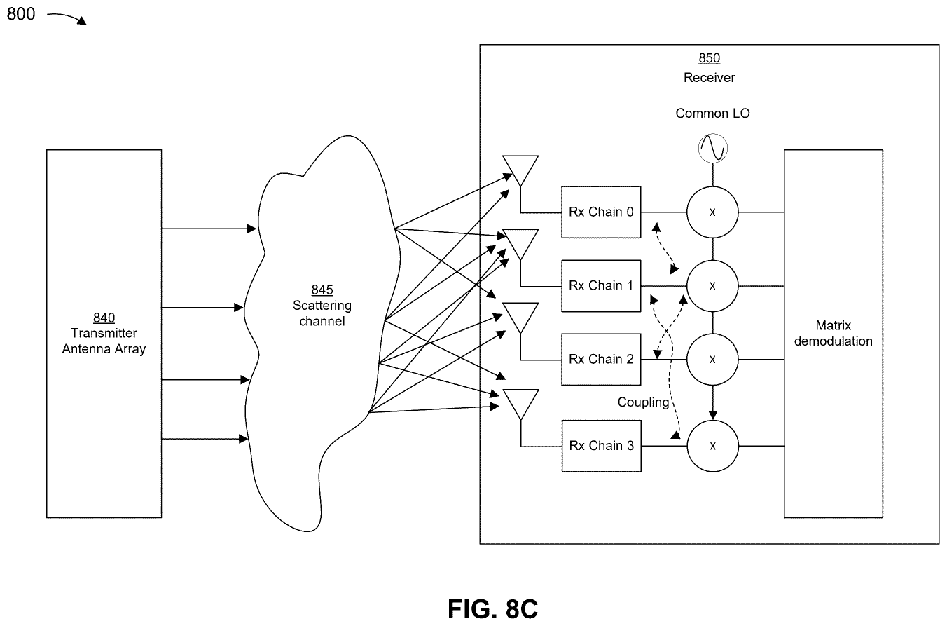

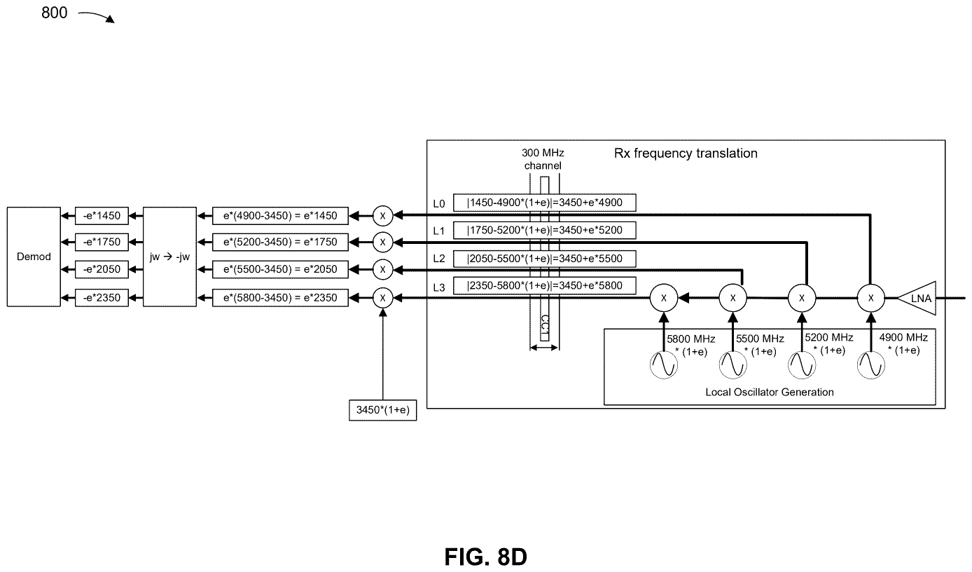

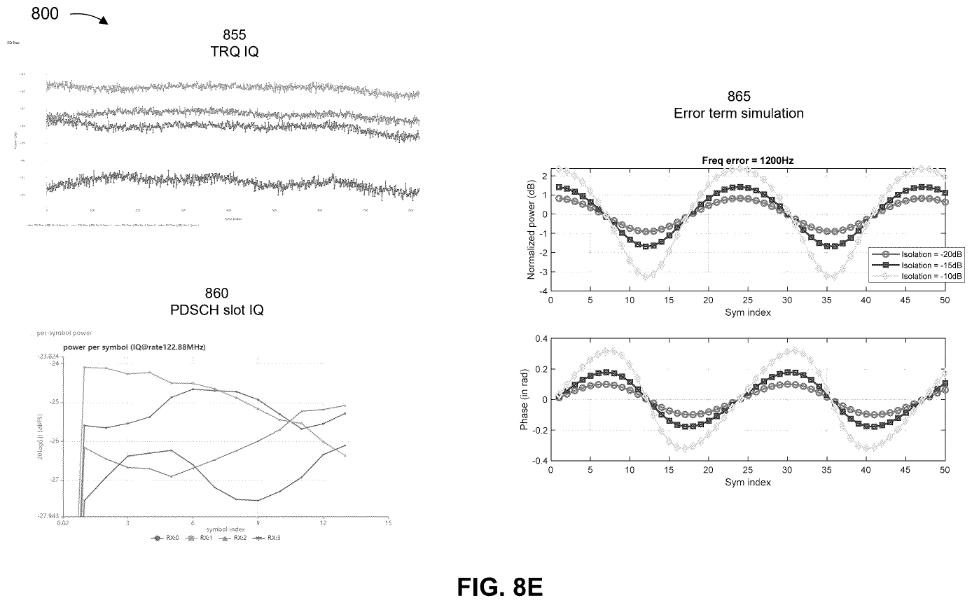

FIGS. 8A-8E are diagrams illustrating examples 800 associated with frequency translation errors that may occur when translating a signal between an FDM configuration and an SDM configuration.

More particularly, as described herein, a communication system that supports using a RAT to communicate over a cable or wired infrastructure (e.g., NRoC or the like) may leverage RAT waveforms and wireless communication techniques to enable broadband communication over coaxial cable networks or other wired infrastructure. NR and other wireless waveforms are generally designed for wireless channels and to exploit spatial diversity of wireless channels to boost throughput. For example, techniques such as MIMO may be used, where an SDM signal includes multiple spatial signals (e.g., multiple spatial layers or multiple data streams) that may be transmitted and/or received over multiple antennas using the same time and frequency resources (e.g., via different beams, or in different spatial directions). In this way, the SDM signal may exploit multipath propagation, while the receiver may employ advanced processing techniques to recover the data stream. However, because cable channels are SISO in nature, and typically have only a single spatial path between a transmitter and a receiver (e.g., the coaxial cable or wire), techniques such as FDM may be applied to enable communication over a wired infrastructure. For example, multiple MIMO layers associated with an SDM transmission may be mixed to different coaxial frequencies or other frequency spectrum associated with the wired infrastructure (e.g., mapped to an FDM configuration) prior to transmission over the wired infrastructure. When the FDM signal is received at the receiver over the cable infrastructure, the receiver may then mix or otherwise map the FDM signal back to an SDM signal that includes multiple spatial layers associated with the same frequency (e.g., an RF) prior to processing at a MIMO transceiver.

For example, as shown in FIG. 8A, a signal translation component 810 that includes one or more mixers, oscillators, filters, and/or other suitable components may be used to translate between SDM and FDM configurations. For example, in some aspects, the signal translation component 810 may receive an SDM MIMO waveform (e.g., an NR waveform or a waveform associated with another suitable RAT) from a MIMO transceiver and map or otherwise translate the SDM MIMO waveform to an FDM MIMO waveform that can then be transmitted over a cable or wired infrastructure. Additionally, the signal translation component 810 may be configured to receive an FDM MIMO waveform over the cable or wired infrastructure and map or otherwise translate the FDM MIMO waveform to an SDM MIMO waveform that can be provided to the MIMO transceiver. In some cases, the signal translation component 810 may be coupled to a front-end of the MIMO transceiver as an external component (e.g., built around an existing MIMO transceiver) and may generally favor a layer-first mapping.

For example, FIG. 8A illustrates an example in which the signal translation component 810 may be implemented in a UE 120 or CPE (or other device). In the example shown in FIG. 8A, downlink communication is configured using three component carriers and four MIMO layers, and uplink communication is configured using two component carriers and two MIMO layers. As shown by reference numbers 805 and 815, a downlink transmission received over a cable is configured as an FDM signal that includes various MIMO layers spaced uniformly within a cable frequency spectrum (e.g., using one or more oscillators, as described in more detail elsewhere herein). Accordingly, for downlink transmission, CCLs that are associated with the same MIMO layer are contiguous or adjacent within the cable frequency spectrum such that the MIMO layers are uniformly spaced in frequency. As described herein, the FDM configuration shown in FIG. 8A may be amenable to using the signal translation component 810 to space the MIMO layers uniformly, and makes RoC or NRoC operation transparent to a MIMO radio or chipset designed for SDM communication. For example, in FIG. 8A, the signal translation component 810 may use four local oscillator signals (shown as xLO0 through xLO3) to mix the FDM signal received on the cable to an SDM signal that includes multiple spatial layers that each include three CCLs. Accordingly, the signal provided to the MIMO modem has the same representation as a four-layer SDM signal.

Similarly, FIG. 8A illustrates an example where uplink communication is configured using two component carriers and two MIMO layers. Accordingly, when the signal translation component 810 receives an uplink signal generated by the MIMO modem or transceiver, the uplink signal is an SDM signal that includes multiple spatial layers. The signal translation component 810 then mixes or maps the SDM signal to an FDM signal that includes various uniformly spaced CCLs suitable for transmission over the cable or wired infrastructure.

In some aspects, the signal translation component 810 may be implemented as an external component in a front-end to a MIMO modem, radio, or transceiver. Additionally, or alternatively, the signal translation component 810 may leverage software-defined radio (SDR) capabilities. Alternatively, in some cases, the frequency translation function performed by the signal translation component 810 may be performed by a transceiver integrated circuit coupled to a MIMO modem, which may be suitable for different component carrier and/or layer mappings that may be useful for network planning. However, MIMO transceivers may not universally support the ROC translation functionality.

As described herein, XOs are often used as reference clock sources in modern digital communications equipment due to XOs having a relatively low cost. For example, FIG. 8B illustrates an example hardware implementation for a frequency translation component, which may be used as a front-end to a radio (e.g., a MIMO transceiver integrated circuit) 825 and a modem 820. As shown in FIG. 8B, the frequency translation component may include an Rx frequency translation component 830 and a Tx frequency translation component 835. In some aspects, the Rx frequency translation component 830 may include one or more mixers, LOs, filters, and/or other suitable components for mapping an FDM signal received over a cable infrastructure to an SDM signal that includes multiple spatial layers that can be provided to the MIMO transceiver. Similarly, the Tx frequency translation component 835 may include one or more mixers, filters, and/or other components for mapping an SDM signal received from the MIMO transceiver to an FDM signal that can be transmitted over the cable or wired infrastructure.

For example, in FIG. 8B, the Rx frequency translation component 830 has a hardware architecture that includes an LNA and four mixers (e.g., driven by four L0 signals, which may be generated by respective LOs or by one or more LOs shared across multiple mixers) to space four MIMO layers uniformly in a frequency space. In some aspects, an FDM signal received via a coaxial cable interface may be passed to a diplexer and impedance match component (not explicitly shown in FIG. 8B, which may be integrated with or used in place of the (SPDT) switch that is coupled to the Rx frequency translation component 830 and the Tx frequency translation component 835), which provides the FDM signal to the Rx frequency translation component 830, starting at the LNA. The FDM signal is then processed using a set of mixers, LOs, and/or filters to map the FDM signal to multiple spatial layers, thereby generating an SDM signal. Furthermore, as shown in FIG. 8B, a similar (reverse) approach may be used for transmissions, where SDM signals generated by the modem 820 and the radio 825 are provided to the Tx frequency translation component 835. The Tx frequency translation component 835 then maps the SDM signal to an FDM signal using one or more mixers, filters, and/or other suitable components such that the FDM signal can be transmitted over the cable infrastructure. In some aspects, the Rx frequency translation component 830 and the Tx frequency translation component 835 may share one or more components (e.g., the LOs and/or a single-pole double-throw (SPDT) switch) or have separate components.

Accordingly, the signal translation component 810 shown in FIG. 8A, the Rx frequency translation component 830, and/or the Tx frequency translation component 835 may be configured to convert between FDM MIMO signals and SDM MIMO signals that may be associated with different frequencies. For example, in the configuration shown in FIG. 8B, an FDM MIMO signal transmitted or received over the cable infrastructure is associated with a first frequency spectrum (e.g., a cable frequency spectrum, such as 1500 to 2700 MHz), and the Rx frequency translation component 830 converts FDM MIMO signals received over the cable infrastructure to SDM MIMO signals associated with a second frequency spectrum (e.g., an NR frequency band, such as an n77 band or a band spanning 2400 to 4500 MHz). For example, the Rx frequency translation component 830 may map the FDM signal to an SDM signal that includes a first MIMO layer associated with a frequency spectrum of 2400 MHz to 3600 MHz, a second MIMO layer associated with a frequency spectrum of 2700 MHz to 3900 MHz, a third MIMO layer associated with a frequency spectrum of 3000 MHz to 4200 MHz, and a fourth MIMO layer associated with a frequency spectrum of 3300 MHz to 4500 MHz (although other suitable frequencies or bands may be used for the FDM signal and/or the SDM signal). Similarly, the Tx frequency translation component 835 may convert an SDM MIMO signal received from the MIMO transceiver from a first frequency spectrum to a second frequency spectrum for an FDM MIMO signal transmitted over the cable infrastructure. In this way, the mixers, LOs, filters, and/or other components in the frequency translation components 830, 835 may rearrange the constituent parts of a transmission over a wired or cable infrastructure to a standard multi-layer RAT configuration and/or rearrange a multi-layer signal associated with a RAT configuration to constituent parts of a transmission suitable to communicate over a wired or cable infrastructure. However, XOs are subject to a higher frequency error and temperature variance compared to more expensive (and more precise) clock sources, such as an OCXO or a VCTCXO. In cases where an XO is used as a reference clock source, the frequency error between the transmitter and the receiver is typically measured and compensated for using digital signal processing techniques in the MIMO modem. However, when an external frequency translator is used to enable translation between an FDM MIMO waveform suitable for transmission over a wired infrastructure and a MIMO waveform that can be received or transmitted by a MIMO transceiver, the frequency translator poses frequency compensation challenges that are not addressed by typical RAT processing flows. Similar challenges may be faced in certain configurations in which the frequency translator is integrated with a transceiver IC.

For example, as shown in FIG. 8C, wireless channels are typically not one-to-one. For example, a transmitter antenna array 840 may be used to transmit multiple spatial streams over a scattering wireless channel 845, which may result in the multiple spatial streams each being received at a receiver 850 via multiple receive antennas that are each coupled to a respective receive chain. The various receive chains are each coupled to a respective mixer and a common LO, which are used to mix the received signal to a different (e.g., intermediate or baseband) frequency suitable for matrix demodulation. In this case, isolation between MIMO layers in wireless radio hardware needs to be sufficient to allow the wireless modem at the receiver to separate the multiple layers using standard signal processing algorithms. For example, 15 to 20 decibels (dB) of RF hardware isolation is generally sufficient to allow the receiver to separate the multiple layers, and achieving a higher RF isolation may increase cost, size, and/or complexity of the radio. However, the limited isolation can lead to poor performance with FDM MIMO transmissions due to uncorrected frequency error from the local frequency reference (e.g., the local XO), which has a typical frequency error from about 1-5 ppm, which varies depending on conditions of the wireless channel 845.

For example, FIG. 8D illustrates how leakage and/or coupling between receive chains and/or layers in an SDR combines with uncorrected frequency error in a mixer to limit receiver performance. In particular, 10-20 dB isolation is typically expected across receive chains in a MIMO transceiver, where the frequency error for each reception layer is corrected in a digital stream rotator after an ADC. For example, as described herein, a time-domain discrete signal denoted x(n) may be associated with a leakage or coupling scaling factor α, an XO error ppm γ, and a digital rotator that corrects a frequency error for each receive chain. As described herein, the frequency error corrected by the digital rotator for each receive chain may be denoted γ×f_{layer}, where f_{layer} is the cable or coaxial frequency of each layer, and Δ_{f} is the frequency difference between adjacent layers.

Accordingly, in a first example where a single-layer transmission x(n) is transmitted on a first layer (L0) only, a baseband signal for a first receive chain (Rx0) may be denoted y₀ (n)=x(n) and a baseband signal for a second receive chain (Rx1) that is leaked from Rx0 may be denoted

$${y}_{1} ( n ) = α x ( n ) {e}^{j 2 π n \frac{{f}_{e}}{{F}_{s}}} ,$$

where fₑ=γΔ_{f} and Fₛ is an ADC sampling rate. When the signal is combined across Rx0 and Rx1 for demodulation, the combined signal is represented as

$${y}_{0} ( n ) + {y}_{1} ( n ) = x ( n ) ( 1 + α {e}^{j 2 π n \frac{{f}_{e}}{{F}_{s}}} ) , where ( 1 + α {e}^{j 2 π n \frac{{f}_{e}}{{F}_{s}}} )$$

is a ppm and leakage dependent error that impacts and/or limits demodulation performance.

In a second example, the signal x(n) may be transmitted on two layers (e.g., L0 and L1), in which case the baseband signal for the first Rx chain may be denoted

$${y}_{0} ( n ) = x ( n ) + α x ( n ) {e}^{- j 2 π n \frac{{f}_{e}}{{F}_{s}}} ,$$

where the additional term

$$α x ( n ) {e}^{- j 2 π n \frac{{f}_{e}}{{F}_{s}}}$$

corresponds to signal leakage from the second Rx chain. In addition to impacting the demodulation performance, the term

$$( 1 + α {e}^{- j 2 π n \frac{{f}_{e}}{{F}_{s}}} )$$

also shows as power-varying signal across symbols, which impacts frequency error, Doppler estimation, channel estimation, and/or other performance. Furthermore, the ppm and leakage dependent error term

$$( 1 + α {e}^{j 2 π n \frac{{f}_{e}}{{F}_{s}}} ) ,$$

implies non-coherent combining for the intended signal, which degrades the decoding performance.

As shown in FIG. 8E, the leakage across layers may result in uncompensated frequency errors for signals that are translated between SDM and FDM configurations by the frequency translation component. For example, reference number 855 depicts an in-phase and quadrature (IQ) capture for a TRS, where the various plots depict the forward power in decibels for a TRS received via different Rx chains in different symbols. For example, the blue plot depicts the forward power for a first Rx chain in a first symbol, the orange plot depicts the forward power for a first Rx chain in a second symbol, the green plot depicts the forward power for a second Rx chain in a first symbol, and the red plot depicts the forward power for the second Rx chain in the second symbol. In another example, reference number 860 depicts an IQ capture for a 4-layer PDSCH transmission, where the blue plot depicts the power per symbol for a first Rx chain, the orange plot depicts the power per symbol for a second Rx chain, the green plot depicts the power per symbol for a third Rx chain, and the red plot depicts the power per symbol for a fourth Rx chain. As shown by reference number 865, simulations of the time-varying error term

$$( 1 + α {e}^{j 2 π n \frac{{f}_{e}}{{F}_{s}}} )$$

are shown, including a simulation of the normalized power (in dB) and phase (in radians) for isolations of −10 dB, −15 dB, and −20 dB.

Accordingly, various aspects described herein relate to techniques to compensate for the frequency error between a transmitter and a receiver (e.g., between a network node and a UE or CPE) when a frequency translator is used to translate an FDM signal received over a cable infrastructure to an SDM signal suitable for processing by a MIMO transceiver and/or to translate an SDM signal received from a MIMO transceiver to an FDM signal suitable for transmission over cable infrastructure.

As indicated above, FIGS. 8A-8E are provided as an example. Other examples may differ from what is described with regard to FIGS. 8A-8E.

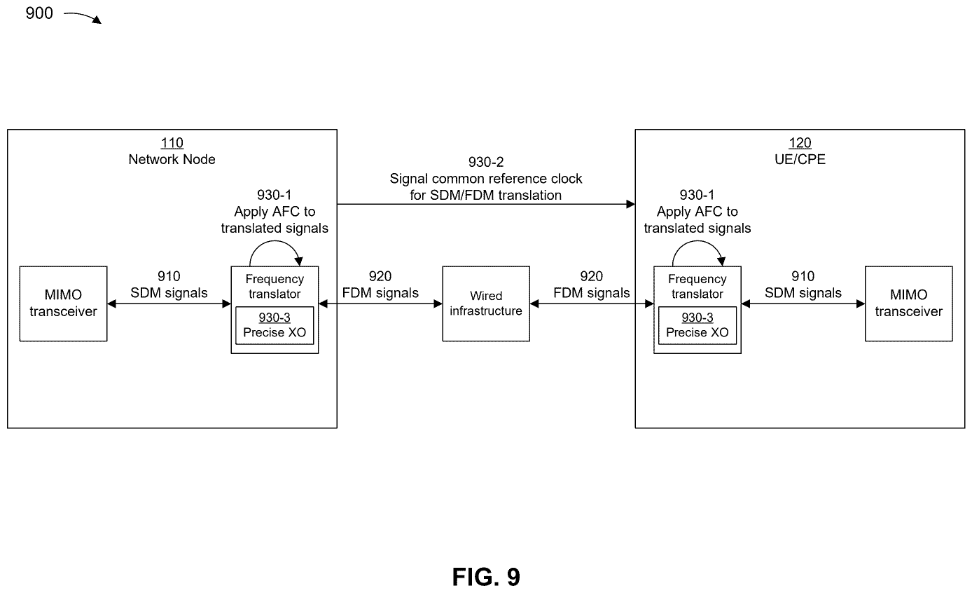

FIG. 9 is a diagram illustrating one or more examples 900 associated with frequency compensation for communicating over a wired infrastructure using a RAT. As shown in FIG. 9, examples 900 include communication between a network node 110 and a UE/CPE 120. In some aspects, the network node 110 and the UE 120 may communicate over a cable or wired infrastructure, and may each be equipped with a MIMO transceiver that can generate and process SDM signals and a frequency translation component that can translate an SDM signal to an FDM signal and/or translate an FDM signal to an SDM signal.

For example, when the network node 110 and the UE/CPE 120 communicate on a downlink, the MIMO transceiver of the network node 110 may provide one or more SDM signals 910 that correspond to downlink transmissions (e.g., PDCCH transmissions, PDSCH transmissions, and/or SSBs, CSI-RS, or other downlink reference signal transmissions) to the frequency translation component, and the frequency translation component may map the SDM signals 910 to FDM signals 920 that can be transmitted to the UE/CPE 120 over the wired infrastructure. At the UE/CPE 120, the FDM signals 920 are received and provided to the frequency translation component, which maps the FDM signals 920 to SDM signals 910 that can be provided to the MIMO transceiver for further processing.

Similarly, when the network node 110 and the UE/CPE 120 communicate on an uplink, the MIMO transceiver of the UE/CPE 120 may provide one or more SDM signals 910 that correspond to uplink transmissions (e.g., PUCCH transmissions, PUSCH transmissions, SRS or other uplink reference signal transmissions) to the frequency translation component, and the frequency translation component may map the SDM signals 910 to FDM signals 920 that can be transmitted to the network node 110 over the wired infrastructure. At the network node 110, the FDM signals 920 are received and provided to the frequency translation component, which maps the FDM signals 920 to SDM signals 910 that can be provided to the MIMO transceiver.

In some aspects, the network node 110 and/or the UE/CPE 120 may be configured to perform one or more frequency compensation techniques to reduce, eliminate, or otherwise mitigate a residual frequency error and/or fast-fluctuation of an FDM signal received or transmitted over the wired infrastructure. For example, as shown by reference number 930-1, the network node 110 and/or the UE/CPE 120 may be configured to apply an AFC to correct the frequency error of the frequency translation component that converts FDM signals to SDM signals and vice versa. For example, at a receiver (e.g., the network node 110 for uplink or the UE/CPE 120 for downlink), Rx AFC may be applied to correct the frequency error of the PLL associated with a mixer used to translate an FDM signal to an SDM signal (e.g., prior to coupling of the layers). In this way, by correcting the frequency error prior to the coupling of the layers instead of correcting the frequency error inside the MIMO transceiver or modem (e.g., via the digital stream rotator or mixer PLL internal to the MIMO transceiver or modem), the frequency error between the network node 110 and the UE/CPE 120 may be eliminated or reduced. For example, the error term

$$( 1 + α {e}^{j 2 π n \frac{{f}_{e}}{{F}_{s}}} )$$

may be reduced to (1+α) when the ppm error of the XO associated with the mixer in the frequency translation component is corrected, thereby enabling coherent combining for the received signal across Rx chains and/or layers. In some aspects, the MIMO transceiver may pass the estimated ppm error of the XO associated with the mixer to a PLL controller or other suitable component of the frequency translation component. Furthermore, different frequency error corrections may be applied at each of the frequency translation component based on the estimated ppm error of the XO associated with the mixer. Thus, AFC operations may be performed at the MIMO transceiver (e.g., the transceiver IC) and/or instructions, data, or information related thereto may be communicated between the MIMO transceiver and the (external) frequency translation component to correct a frequency error.

Additionally, or alternatively, at the transmitter (e.g., the network node 110 for downlink or the UE/CPE 120 for uplink), Tx AFC may be applied to correct the frequency error of each mixer that the frequency translation component uses to map an SDM signal to an FDM signal (e.g., post coupling of the layers). In this way, by correcting the frequency error after the layers have been coupled rather than correcting the frequency error inside the MIMO transceiver or modem (e.g., via the internal mixer PLL the MIMO transceiver or modem), the frequency error between the network node 110 and the UE/CPE 120 may be eliminated or reduced. Furthermore, similar to the receiver, an interface may be used to pass the estimated ppm error of the XO associated with the frequency translation component from the MIMO transceiver to the frequency translation component of the transmitter, and different frequency error correction may be applied at each mixer used to translate an SDM signal to an FDM signal based on the estimated ppm error of the XO associated with the frequency translation component.

Additionally, or alternatively, as shown by reference number 930-2, the network node 110 may broadcast, transmit, or otherwise signal a common reference clock to the UE/CPE 120, such that the frequency translation components of the network node 110 and the UE/CPE 120 use the common reference clock to translate FDM signals to SDM signals and vice versa. In this way, using the common reference clock may eliminate or reduce the residual frequency error and the fast-fluctuation of a signal generated and/or processed by a MIMO transceiver. For example, in some aspects, the common reference clock may be broadcast, transmitted, or otherwise signaled by the network node 110 over the wired infrastructure to all UE/CPEs 120 via signaling that is in-band or out-of-band with respect to regular traffic, NRoC traffic, DOCSIS traffic, or legacy CATV service traffic. Additionally, or alternatively, as shown by reference number 930-3, the frequency translation component of the network node 110 and/or the UE/CPE 120 may include a high-precision calibrated component that is used to provide the reference frequency for translating between FDM signals and SDM signals. For example, rather than using a low-precision XO with an error that is typically measured in ppm, the frequency translation component of the network node 110 and/or the UE/CPE 120 may be equipped with a high-precision component that can provide a very precise reference frequency for translating between the frequencies associated with the SDM and FDM signals. For example, in some aspects, the precise component may be a highly precise XO, such as an OCXO, a VCTCXO, or another suitable XO that has an error typically measured in parts-per-billion (ppb). The XO 930-3 is shown as being included in the frequency translator in the configuration illustrated in FIG. 9. In other examples, the XO 930-3 is implemented external to the frequency translator. In some examples, the XO 930-3 is coupled to both (e.g., shared by) the frequency translation and the MIMO transceiver. In some such examples, the frequency translation, MIMO transceiver, and XO are coupled via a main board of the network node 110 or UE/CPE 120.

As indicated above, FIG. 9 is provided as an example. Other examples may differ from what is described with respect to FIG. 9.

FIG. 10 is a diagram illustrating an example process 1000 performed, for example, at a receiver or an apparatus of a receiver. Example process 1000 is an example where the apparatus or the receiver (e.g., a UE 120 for downlink communication, or a network node 110 for uplink communication) performs operations associated with frequency compensation for communicating over wired infrastructure using a RAT.

As shown in FIG. 10, in some aspects, process 1000 may include receiving, from a transmitter over a wired infrastructure, an FDM signal (block 1010). For example, the receiver (e.g., using reception component 1202 and/or communication manager 1206, depicted in FIG. 12) may receive, from a transmitter over a wired infrastructure, an FDM signal, as described above.

As further shown in FIG. 10, in some aspects, process 1000 may include mapping the FDM signal to an SDM signal that includes multiple spatial layers, wherein the SDM signal mapped to the FDM signal compensates for a frequency error between the transmitter and the receiver (block 1020). For example, the receiver (e.g., using communication manager 1206, depicted in FIG. 12) may map the FDM signal to an SDM signal that includes multiple spatial layers, wherein the SDM signal mapped to the FDM signal compensates for a frequency error between the transmitter and the receiver, as described above.

As further shown in FIG. 10, in some aspects, process 1000 may include providing the SDM signal to MIMO transceiver (block 1030). For example, the receiver (e.g., using communication manager 1206, depicted in FIG. 12) may provide the SDM signal to a MIMO transceiver, as described above.

Process 1000 may include additional aspects, such as any single aspect or any combination of aspects described below and/or in connection with one or more other processes described elsewhere herein.

In a first aspect, mapping the FDM signal to the SDM signal includes applying an AFC to the frequency translation component to compensate for the frequency error.

In a second aspect, alone or in combination with the first aspect, the AFC is applied per spatial layer based at least in part on an estimated error of one or more oscillators associated with the frequency translation component.

In a third aspect, alone or in combination with one or more of the first and second aspects, the AFC is applied per spatial layer based at least in part on respective absolute frequency errors associated with the multiple spatial layers.

In a fourth aspect, alone or in combination with one or more of the first through third aspects, the FDM signal and the SDM signal are associated with a common reference clock used at both the transmitter and the receiver to compensate for the frequency error between the transmitter and the receiver.

In a fifth aspect, alone or in combination with one or more of the first through fourth aspects, process 1000 includes receiving, from the transmitter over the wired infrastructure, signaling that indicates the common reference clock.

In a sixth aspect, alone or in combination with one or more of the first through fifth aspects, process 1000 includes transmitting, to the transmitter over the wired infrastructure, signaling that indicates the common reference clock.

In a seventh aspect, alone or in combination with one or more of the first through sixth aspects, the common reference clock is configured by a network node using in-band signaling with respect to the FDM signal.

In an eighth aspect, alone or in combination with one or more of the first through seventh aspects, the common reference clock is configured by a network node using out-of-band signaling with respect to the FDM signal.

In a ninth aspect, alone or in combination with one or more of the first through eighth aspects, the FDM signal is mapped to the SDM signal using an OCXO as a reference clock source.

In a tenth aspect, alone or in combination with one or more of the first through ninth aspects, the FDM signal is mapped to the SDM signal using a VCTCXO as a reference clock source.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a transmitter or an apparatus of a transmitter. Example process 1100 is an example where the apparatus or the transmitter (e.g., a UE 120 for uplink communication, or a network node 110 for downlink communication) performs operations associated with frequency compensation for communicating over wired infrastructure using a RAT.

As shown in FIG. 11, in some aspects, process 1100 may include providing an SDM signal that includes multiple spatial layers to a frequency translation component (block 1110). For example, the transmitter (e.g., using communication manager 1306, depicted in FIG. 13) may provide an SDM signal that includes multiple spatial layers to a frequency translation component, as described above.

As further shown in FIG. 11, in some aspects, process 1100 may include mapping the SDM signal to an FDM signal (block 1120). For example, the transmitter (e.g., using communication manager 1306, depicted in FIG. 13) may map the SDM signal to an FDM signal, as described above.

As further shown in FIG. 11, in some aspects, process 1100 may include transmitting, to a receiver over a wired infrastructure, the FDM signal, wherein the FDM signal transmitted over the wired infrastructure compensates for a frequency error between the transmitter and the receiver (block 1130). For example, the transmitter (e.g., using transmission component 1304 and/or communication manager 1306, depicted in FIG. 13) may transmit, to a receiver over a wired infrastructure, the FDM signal, wherein the FDM signal transmitted over the wired infrastructure compensates for a frequency error between the transmitter and the receiver, as described above.

Process 1100 may include additional aspects, such as any single aspect or any combination of aspects described below and/or in connection with one or more other processes described elsewhere herein.

In a first aspect, mapping the SDM signal to the FDM signal includes applying an AFC to the frequency translation component to compensate for the frequency error.

In a second aspect, alone or in combination with the first aspect, the AFC is applied per spatial layer based at least in part on an estimated error of one or more oscillators associated with the frequency translation component.

In a third aspect, alone or in combination with one or more of the first and second aspects, the AFC is applied per spatial layer based at least in part on respective absolute frequency errors associated with the multiple spatial layers.

In a fourth aspect, alone or in combination with one or more of the first through third aspects, the FDM signal and the SDM signal are associated with a common reference clock used at both the transmitter and the receiver to compensate for the frequency error between the transmitter and the receiver.

In a fifth aspect, alone or in combination with one or more of the first through fourth aspects, process 1100 includes receiving, from the receiver over the wired infrastructure, signaling that indicates the common reference clock.

In a sixth aspect, alone or in combination with one or more of the first through fifth aspects, process 1100 includes transmitting, to the receiver over the wired infrastructure, signaling that indicates the common reference clock.

In a seventh aspect, alone or in combination with one or more of the first through sixth aspects, the common reference clock is configured by a network node using in-band signaling with respect to the FDM signal.

In an eighth aspect, alone or in combination with one or more of the first through seventh aspects, the common reference clock is configured by a network node using out-of-band signaling with respect to the FDM signal.

In a ninth aspect, alone or in combination with one or more of the first through eighth aspects, the SDM signal is mapped to the FDM signal using an OCXO as a reference clock source.

In a tenth aspect, alone or in combination with one or more of the first through ninth aspects, the SDM signal is mapped to the FDM signal using a VCTCXO as a reference clock source.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a receiver, or a receiver may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 and/or the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 140 and/or the processing system 145 described in connection with FIG. 1) of the receiver.

In some aspects, the apparatus 1200 may be configured to perform one or more operations described herein in connection with FIGS. 4A-4F, FIG. 5, FIGS. 6A-6C, FIGS. 7A-7B, FIGS. 8A-8E, and/or FIG. 9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE or the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the UE or the network node described above in connection with FIG. 1, such as a radio, one or more RF chains, one or more transceivers, or one or more modems, each of which may in turn be coupled with one or more antennas of the receiver.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the receiver described above in connection with FIG. 1, such as a radio, one or more RF chains, one or more transceivers, or one or more modems, each of which may in turn be coupled with one or more antennas of the receiver described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from a transmitter over a wired infrastructure, an FDM signal. The communication manager 1206 may map the FDM signal to an SDM signal that includes multiple spatial layers, wherein the SDM signal mapped to the FDM signal compensates for a frequency error between the transmitter and the receiver. The communication manager 1206 may provide the SDM signal to a MIMO transceiver.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 13 is a diagram of an example apparatus 1300 for wireless communication. The apparatus 1300 may be a transmitter, or a transmitter may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 and/or the communication manager 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 and/or the processing system 145 described in connection with FIG. 1) of the transmitter.

In some aspects, the apparatus 1300 may be configured to perform one or more operations described herein in connection with FIGS. 4A-4F, FIG. 5, FIGS. 6A-6C, FIGS. 7A-7B, FIGS. 8A-8E, and/or FIG. 9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE or the network node described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the UE or the network node described above in connection with FIG. 1, such as a radio, one or more RF chains, one or more transceivers, or one or more modems, each of which may in turn be coupled with one or more antennas of the transmitter.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the transmitter described above in connection with FIG. 1, such as a radio, one or more RF chains, one or more transceivers, or one or more modems, each of which may in turn be coupled with one or more antennas of the transmitter described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The communication manager 1306 may provide an SDM signal that includes multiple spatial layers to a frequency translation component. The communication manager 1306 may map the SDM signal to an FDM signal. The transmission component 1304 may transmit, to a receiver over a wired infrastructure, the FDM signal, wherein the FDM signal transmitted over the wired infrastructure compensates for a frequency error between the transmitter and the receiver.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of communication performed by a receiver, comprising: receiving, from a transmitter over a wired infrastructure, a frequency division multiplexed (FDM) signal; mapping, by a frequency translation component, the FDM signal to a spatial division multiplexed (SDM) signal that includes multiple spatial layers, wherein the SDM signal mapped to the FDM signal compensates for a frequency error between the transmitter and the receiver; and providing the SDM signal to a multiple-input multiple-output (MIMO) transceiver.
Aspect 2: The method of Aspect 1, wherein mapping the FDM signal to the SDM signal includes applying an automatic frequency control (AFC) to the frequency translation component to compensate for the frequency error.
Aspect 3: The method of Aspect 2, wherein the AFC is applied per spatial layer based at least in part on an estimated error of one or more oscillators associated with the frequency translation component.
Aspect 4: The method of Aspect 2, wherein the AFC is applied per spatial layer based at least in part on respective absolute frequency errors associated with the multiple spatial layers.
Aspect 5: The method of any of Aspects 1-4, wherein the FDM signal and the SDM signal are associated with a common reference clock used at both the transmitter and the receiver to compensate for the frequency error between the transmitter and the receiver.
Aspect 6: The method of Aspect 5, further comprising: receiving, from the transmitter over the wired infrastructure, signaling that indicates the common reference clock.
Aspect 7: The method of Aspect 5, further comprising: transmitting, to the transmitter over the wired infrastructure, signaling that indicates the common reference clock.
Aspect 8: The method of Aspect 5, wherein the common reference clock is configured by a network node using in-band signaling with respect to the FDM signal.
Aspect 9: The method of Aspect 5, wherein the common reference clock is configured by a network node using out-of-band signaling with respect to the FDM signal.
Aspect 10: The method of any of Aspects 1-9, wherein the FDM signal is mapped to the SDM signal using an oven-controlled crystal oscillator (OCXO) as a reference clock source.
Aspect 11: The method of any of Aspects 1-10, wherein the FDM signal is mapped to the SDM signal using a voltage-controlled temperature-compensated crystal oscillator (VCTCXO) as a reference clock source.
Aspect 12: A method of communication performed by a transmitter, comprising: providing, by a multiple-input multiple-output (MIMO) transceiver, a spatial division multiplexed (SDM) signal that includes multiple spatial layers to a frequency translation component; mapping, by the frequency translation component, the SDM signal to a frequency division multiplexed (FDM) signal; and transmitting, to a receiver over a wired infrastructure, the FDM signal, wherein the FDM signal transmitted over the wired infrastructure compensates for a frequency error between the transmitter and the receiver.
Aspect 13: The method of Aspect 12, wherein mapping the SDM signal to the FDM signal includes applying an automatic frequency control (AFC) to the frequency translation component to compensate for the frequency error.
Aspect 14: The method of Aspect 13, wherein the AFC is applied per spatial layer based at least in part on an estimated error of one or more oscillators associated with the frequency translation component.
Aspect 15: The method of Aspect 13, wherein the AFC is applied per spatial layer based at least in part on respective absolute frequency errors associated with the multiple spatial layers.
Aspect 16: The method of any of Aspects 12-15, wherein the FDM signal and the SDM signal are associated with a common reference clock used at both the transmitter and the receiver to compensate for the frequency error between the transmitter and the receiver.
Aspect 17: The method of Aspect 16, further comprising: receiving, from the receiver over the wired infrastructure, signaling that indicates the common reference clock.
Aspect 18: The method of Aspect 16, further comprising: transmitting, to the receiver over the wired infrastructure, signaling that indicates the common reference clock.
Aspect 19: The method of Aspect 16, wherein the common reference clock is configured by a network node using in-band signaling with respect to the FDM signal.
Aspect 20: The method of Aspect 16, wherein the common reference clock is configured by a network node using out-of-band signaling with respect to the FDM signal.
Aspect 21: The method of any of Aspects 12-20, wherein the SDM signal is mapped to the FDM signal using an oven-controlled crystal oscillator (OCXO) as a reference clock source.
Aspect 22: The method of any of Aspects 12-21, wherein the SDM signal is mapped to the FDM signal using a voltage-controlled temperature-compensated crystal oscillator (VCTCXO) as a reference clock source.
Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.
Aspect 24: An apparatus for wireless communication at a device, the apparatus comprising one or more memories and one or more processors coupled to the one or more memories, the one or more processors configured to cause the device to perform the method of one or more of Aspects 1-22.
Aspect 25: An apparatus for wireless communication, the apparatus comprising at least one means for performing the method of one or more of Aspects 1-22.
Aspect 26: A non-transitory computer-readable medium storing code for wireless communication, the code comprising instructions executable by one or more processors to perform the method of one or more of Aspects 1-22.
Aspect 27: A non-transitory computer-readable medium storing a set of instructions for wireless communication, the set of instructions comprising one or more instructions that, when executed by one or more processors of a device, cause the device to perform the method of one or more of Aspects 1-22.
Aspect 28: A device for wireless communication, the device comprising a processing system that includes one or more processors and one or more memories coupled with the one or more processors, the processing system configured to cause the device to perform the method of one or more of Aspects 1-22.
Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for communication at a receiver, comprising:
one or more memories; and
one or more processors, coupled to the one or more memories, configured to cause the receiver to:
receive, from a transmitter over a wired infrastructure, a frequency division multiplexed (FDM) signal;
map, by a frequency translation component, the FDM signal to a spatial division multiplexed (SDM) signal that includes multiple spatial layers, wherein the SDM signal mapped to the FDM signal compensates for a frequency error between the transmitter and the receiver; and
provide the SDM signal to a multiple-input multiple-output (MIMO) transceiver.

2. The apparatus of claim 1, wherein the one or more processors, to map the FDM signal to the SDM signal, are further configured to cause the receiver to apply an automatic frequency control (AFC) to the frequency translation component to compensate for the frequency error.

3. The apparatus of claim 2, wherein the AFC is applied per spatial layer based at least in part on an estimated error of one or more oscillators associated with the frequency translation component.

4. The apparatus of claim 2, wherein the AFC is applied per spatial layer based at least in part on respective absolute frequency errors associated with the multiple spatial layers.

5. The apparatus of claim 1, wherein the FDM signal and the SDM signal are associated with a common reference clock used at both the transmitter and the receiver to compensate for the frequency error between the transmitter and the receiver.

6. The apparatus of claim 5, wherein the one or more processors are further configured to cause the receiver to:
receive, from the transmitter over the wired infrastructure, signaling that indicates the common reference clock.

7. The apparatus of claim 5, wherein the one or more processors are further configured to cause the receiver to:
transmit, to the transmitter over the wired infrastructure, signaling that indicates the common reference clock.

8. The apparatus of claim 5, wherein the common reference clock is configured by a network node using in-band signaling with respect to the FDM signal.

9. The apparatus of claim 5, wherein the common reference clock is configured by a network node using out-of-band signaling with respect to the FDM signal.

10. The apparatus of claim 1, wherein the FDM signal is mapped to the SDM signal using an oven-controlled crystal oscillator (OCXO) as a reference clock source.

11. The apparatus of claim 1, wherein the FDM signal is mapped to the SDM signal using a voltage-controlled temperature-compensated crystal oscillator (VCTCXO) as a reference clock source.

12. An apparatus for communication at a transmitter, comprising:
one or more memories; and
one or more processors, coupled to the one or more memories, configured to cause the transmitter to:
provide, by a multiple-input multiple-output (MIMO) transceiver, a spatial division multiplexed (SDM) signal that includes multiple spatial layers to a frequency translation component;
map, by the frequency translation component, the SDM signal to a frequency division multiplexed (FDM) signal; and
transmit, to a receiver over a wired infrastructure, the FDM signal, wherein the FDM signal transmitted over the wired infrastructure compensates for a frequency error between the transmitter and the receiver.

13. The apparatus of claim 12, wherein the one or more processors, to map the SDM signal to the FDM signal, are further configured to cause the transmitter to apply an automatic frequency control (AFC) to the frequency translation component to compensate for the frequency error.

14. The apparatus of claim 13, wherein the AFC is applied per spatial layer based at least in part on an estimated error of one or more oscillators associated with the frequency translation component.

15. The apparatus of claim 13, wherein the AFC is applied per spatial layer based at least in part on respective absolute frequency errors associated with the multiple spatial layers.

16. The apparatus of claim 12, wherein the FDM signal and the SDM signal are associated with a common reference clock used at both the transmitter and the receiver to compensate for the frequency error between the transmitter and the receiver.

17. The apparatus of claim 16, wherein the common reference clock is configured by a network node using out-of-band signaling with respect to the FDM signal.

18. The apparatus of claim 12, wherein the SDM signal is mapped to the FDM signal using an oven-controlled crystal oscillator (OCXO) as a reference clock source.

19. The apparatus of claim 12, wherein the SDM signal is mapped to the FDM signal using a voltage-controlled temperature-compensated crystal oscillator (VCTCXO) as a reference clock source.

20. A method for communication performed by a receiver, comprising:
receiving, from a transmitter over a wired infrastructure, a frequency division multiplexed (FDM) signal;
mapping, by a frequency translation component, the FDM signal to a spatial division multiplexed (SDM) signal that includes multiple spatial layers, wherein the SDM signal mapped to the FDM signal compensates for a frequency error between the transmitter and the receiver; and
providing the SDM signal to a multiple-input multiple-output (MIMO) transceiver.
